(19) United States
(12) Patent Application Publication
(10) Pub. No.: US 2019/0251538 A1
(43) Pub. Date: Aug. 15, 2019

(54) SYSTEMS AND METHODS FOR REMOTELY EXECUTING TRANSACTIONS VIA APPLICATIONS AND POINT OF SALE SYSTEMS

(71) Applicant: OnMe App LLC, Littleton, CO (US)

(72) Inventors: Michael Donald Grosh, Denver, CO (US); Bradley Joseph Nietfeldt, Omaha, NE (US)

(73) Assignee: OnMe App LLC, Littleton, CO (US)

(21) Appl. No.: 16/271,142

(22) Filed: Feb. 8, 2019

Related U.S. Application Data
(60) Provisional application No. 62/628,427, filed on Feb. 9, 2018.

(51) Int. Cl. G06Q 20/20; G06Q 20/14; G06Q 20/40

(52) U.S. Cl. CPC G06Q 20/206; G06Q 2220/00; G06Q 20/401; G06Q 20/14

(57) ABSTRACT

Described embodiments provide systems and methods for remotely executing transactions to purchase items on behalf of users. A server may receive, from a first client, an indication that a first user is at an establishment having a point of sale (POS) system. The server may provide, to a second client, a notification that the first user is at the establishment. The server may receive, from the second client, a request to initiate a transaction to purchase items selected by the second user for the first user. The server may provide, to the first client, the request for acceptance or rejection. The server may receive, from the first client, a response indicating acceptance. The server may authenticate the second user on the second client with the server to establish a communication channel. The server may receive, via the communication channel, transaction data to carry out the transaction via the POS system.

### CROSS REFERENCES TO RELATED APPLICATIONS

This application claims the benefit of priority under 35 U.S.C. § 119(e) to Provisional Application No. 62/628,427, titled “SYSTEMS AND METHODS FOR PURCHASING AN ITEM FOR ANOTHER PERSON VIA AN APPLICATION AND POINT OF SALE SYSTEMS,” filed Feb. 9, 2018, which is incorporated herein in its entirety.

### TECHNICAL FIELD

The present application relates generally to point of sale systems, and in particular systems and methods for remotely executing transactions via applications and point of sale systems.

### BACKGROUND

Point of sales (POS) systems may be used to carry out a transaction between two or more entities for various products or services. Examples of POS systems may include cash registers, barcode scanners, and payment terminals, among other devices. In current POS systems, entities may manage and conduct the transaction directly with one another.

### SUMMARY

Various embodiments disclosed herein provide systems and methods for purchasing an item for another person via an application and point of sales systems. An application for carrying out transactions in connection to gifts may be provided to two clients for two respective end users and a point of sale (POS) systems. The application may function as an open application program interface (API) or nuclear system to integrate and connect end users via social media, POS systems, and mobile payment systems. One of the objectives of the application may be to allow end users on clients to virtually send a gift by purchasing an item for other end users, while at the location of the transaction (e.g., restaurant or retail store). Another objective of the application may include communicating to the end users a message in real time notifying of the purchase of the item while at the location.

Under the transaction scheme of the present systems and methods, end users may have downloaded the gift transaction application from a digital distribution platform (e.g., an application store), and installed the application onto the respective clients. Using the application running on the client, each user may setup a billing profile. When at a vendor location (e.g., restaurant or retail store), the end user may check-in with the vendor location using the application. A POS system of the vendor may have been provided with another application.

In an example of a gift transaction from one end user to another end user via the application, when a first end user arrives at a restaurant for a reservation, the first end user may use the gift transaction application to check-in with the restaurant. By checking in, the application on the client of the first end user may notify other end users of a social network connected through the application that the first end user is at the restaurant. The social network may be established in the application by interfacing with another social networking platform or through a contacts list on the client. The application may be used to limit the number of other end users of the social network (e.g., ten people from family members, close friends, customers, and prospects on the social network) to which to send the notification by the first end user.

Once the first end user is seated at a table in the restaurant, a server (e.g., a waiter) may use the application on the POS system to identify and to confirm which table the first end user is seated in the restaurant. The POS system may in turn send a notification to the end users connected with the social network of the first end user. On the profile of the first end user, a green light indicator may appear to indicate to connect end users on the social network that the first end user is seated at the restaurant and is able to receive an item via the gift transaction application in real time during dining.

From the end users connected to the social network of the first end user, a second end user (e.g., a friend of the first end user) may see a notification in the gift transaction application that the first end user is at the restaurant. Via a drop down box on the application, the second end user may send the first end user a round of drinks. Once the first end user confirms receipt of the item by the second user, the order by the second end user may be sent directly to the POS system of the restaurant. When the transaction is complete and the server confirms the order on the POS system, the first end user may receive a confirmation of the transaction via a text message. The amount charged to the billing profile of the second end user may include not only the price of the item but also an automatically calculated gratuity fee and a transaction fee. The first end user may also receive a text message notifying that the billing profile of the first end user has not been charged for the item.

Subsequently, the server may take the round of drinks to the first end user, and then may use the application on the POS system to enter that the transaction has occurred, that the order is fulfilled, and that the drinks have been delivered. Upon entry on the application at the POS system, a notification may be triggered and be sent to the first end user. The transaction may be added to the newsfeed on the application for the other end users connected to the first end user via the social network. In this manner, the other end users may see that the occurrence of the transaction, in which turn may encourage other end users in the social network to buy other items for the first end user. Multiple transactions as these may occurred throughout the first end user's dining at the restaurant. With this seamless transaction process, additional outside revenue may be provided to restaurants and end users of the mutual social network may be allowed to provide gift transactions to one another, thereby further aiding the experience of the social network.

At least one aspect of this disclosure is directed to a method of remotely executing transactions to point of sale systems of establishments to purchase items on behalf of users. A server having one or more processors may receive, from a first client via a network, an indication that a first end user of the first client is at an establishment having a point of sale (POS) system. The server may identify, responsive to receiving the indication, information regarding one or more items offered for purchase at an establishment associated with the POS system. The server may provide, to a second client of a second end user via the network, a notification that the first end user is at the establishment. The notification may include one or more items to select by the second end user to purchase at the establishment via the POS system on behalf of the first end user. The server may receive, from the second client via the network, a request to initiate a transaction to purchase one or more items via the POS system selected by the second end user on the second client on behalf of the first end user on the first client. The request may include one or more items selected by the second end user and a transaction amount. The server may provide, to the first client via the network, the request to initiate the transaction for acceptance or rejection by the first end user of the first client. The server may receive, from the first client via the network, a response indicating acceptance of the transaction by the first end user of the first client to the request to initiate the transaction. The server may authenticate, responsive to receiving the response indicating acceptance of the transaction, the second end user on the second client with the server to establish an encrypted communication channel between the second client and the server over the network. The server may receive, via the encrypted communication channel established over the network, transaction data to carry out the transaction via the POS system. The transaction data may include the transaction amount and a billing information for the second end user. The server may provide the transaction data to the POS system to carry out the transaction via the POS system in accordance with the transaction amount and the billing information included in the transaction information.

In some embodiments, receiving the indication may include receiving the indication corresponding to a check-in via a first application running on the first client to the establishment at which the first user is located. In some embodiments, providing the notification that the first end user is at the establishment may include identifying, from a plurality of end users, the second end user as associated with the first end user based on the indication that the first end user of the first client is at the establishment. In some embodiments, providing the notification that the first end user is at the establishment may include causing an application running on the second client to present the indication on a graphical user interface of the application to denote that the first end user is at the establishment and a list including the one or more items offered for purchase at the establishment. In some embodiments, providing the request to initiate may include causing an application running on the first client to present a prompt to the first end user to indicate the selected item to purchase the establishment and to accept or reject the notification.

In some embodiments, authenticating the second end user may include using one or more keys generated based on the acceptance message from the first end user to establish the encrypted communication channel between the second client and the server. In some embodiments, receiving the transaction data may include receiving the transaction data generated in accordance with a predefined format specified by an application programming interface (API). In some embodiments, the server may authenticate, responsive to authenticating with the second client, the POS system with the server to establish a second encrypted communication channel between the POS system and the server to forward the transaction data received from the second client via the encrypted communication channel.

In some embodiments, the server may interface, via the network, with a reservation management system (RMS) to access calendar events of the first end user of the first client regarding the establishment. In some embodiments, the server may receive, via the network, a return message from the POS system responsive to carrying out the transaction in accordance with the transaction amount and the billing information. The return message may indicate one of success or failure in carrying out the transaction via the POS system to provide the selected item to the first end user

At least one aspect of this disclosure is directed to a system for remotely executing transactions to point of sale systems of establishments to purchase items on behalf of users. The system may include a check-in tracker executable on a server having one or more processors. The check-in tracker may receive, from a first client via a network, an indication that a first end user of the first client is at an establishment having a point of sale (POS) system. The check-in tracker may identify, responsive to receiving the indication, information regarding one or more items offered for purchase at an establishment associated with the POS system. The check-in tracker may provide, to a second client of a second end user via the network, a notification that the first end user is at the establishment. The notification may include one or more items to select by the second end user to purchase at the establishment via the POS system on behalf of the first end user. The system may include a request handler executable on the server. The request handler may receive, from the second client via the network, a request to initiate a transaction to purchase one or more items via the POS system selected by the second end user on the second client on behalf of the first end user on the first client. The request may include one or more items selected by the second end user and a transaction amount. The request handler may provide, to the first client via the network, the request to initiate the transaction for acceptance or rejection by the first end user of the first client. The request handler may receive, from the first client via the network, a response indicating acceptance of the transaction by the first end user of the first client to the request to initiate the transaction. The system may include a user authenticator executable on the server. The user authenticator may authenticate, responsive to receiving the response indicating acceptance of the transaction, the second end user on the second client with the server to establish an encrypted communication channel between the second client and the server over the network. The system may include a transaction processor executable on the server. The transaction processor may receive, via the encrypted communication channel established over the network, transaction data to carry out the transaction via the POS system, the transaction data including the transaction amount and a billing information for the second end user. The transaction processor may provide the transaction data to the POS system to carry out the transaction via the POS system in accordance with the transaction amount and the billing information included in the transaction information.

In some embodiments, the check-in tracker may receive the indication corresponding to a check-in via a first application running on the first client to the establishment at which the first user is located. In some embodiments, the check-in tracker may identify, from a plurality of end users, the second end user as associated with the first end user based on the indication that the first end user of the first client is at the establishment. In some embodiments, the check-in tracker may cause an application running on the second client to present the indication on a graphical user interface of the application to denote that the first end user is at the establishment and a list including the one or more items offered for purchase at the establishment. In some embodiments, the request handler may cause an application running on the first client to present a prompt to the first end user to indicate the selected item to purchase the establishment and to accept or reject the notification

In some embodiments, the user authenticator may use one or more keys generated based on the acceptance message from the first end user to establish the encrypted communication channel between the second client and the server. In some embodiments, the user authenticator may receive the transaction data generated in accordance with a predefined format specified by an application programming interface (API). In some embodiments, the user authenticator may authenticate, responsive to authenticating with the second client, the POS system with the server to establish a second encrypted communication channel between the POS system and the server to forward the transaction data received from the second client via the encrypted communication channel.

In some embodiments, the check-in tracker may interface, via the network, with a reservation management system (RMS) to access calendar events of the first end user of the first client regarding the establishment. In some embodiments, the transaction processor may receive, via the network, a return message from the POS system responsive to carrying out the transaction in accordance with the transaction amount and the billing information. The return message may indicate one of success or failure in carrying out the transaction via the POS system to provide the selected item to the first end user.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

It should be understood that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a block diagram depicting an embodiment of a system for purchasing an item for another person via an application and point of sales systems;

FIGS. 2A-2T are screenshots of graphical user interfaces (GUIs) of an end-user application for purchasing an item for another person via an application and point of sales systems;

FIGS. 3A-3E are screenshots of graphical user interfaces (GUIs) of an advertising campaign application for purchasing an item for another person via an application and point of sales systems;

FIG. 4 is a flow diagram depicting an embodiment of a method of purchasing an item for another person via an application and point of sales systems;

FIG. 5A is a block diagram depicting an embodiment of a network environment comprising client devices in communication with server devices;

FIG. 5B is a block diagram depicting a cloud computing environment comprising client devices in communication with a cloud service provider; and

FIGS. 5C and 5D are block diagrams depicting embodiments of computing devices useful in connection with the methods and systems described herein.

The features and advantages of the concepts disclosed herein will become more apparent from the detailed description set forth below when taken in conjunction with the drawings.

### DETAILED DESCRIPTION

Following below are more detailed descriptions of various concepts related to, and embodiments of, inventive systems and methods for purchasing an item for another person via an application and point of sales systems. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes embodiments of systems and methods for remotely executing transactions via applications and point of sale systems.

Section B describes a network environment and computing environment which may be useful for practicing various computing related embodiments described herein.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

### A. Systems and Methods for Remotely Executing Transactions via Applications and Point of Sale Systems

Various embodiments disclosed herein provide systems and methods for purchasing an item for another person via an application and point of sales systems. An application for carrying out transactions in connection to gifts may be provided to two clients for two respective end users and a point of sale (POS) systems. The application may function as an open application program interface (API) or nuclear system to integrate and connect end users via social media, POS systems, and mobile payment systems. One of the objectives of the application may be to allow end users on clients to virtually send a gift by purchasing an item for other end users, while at the location of the transaction (e.g., restaurant or retail store). Another objective of the application may include communicating to the end users a message in real time notifying of the purchase of the item while at the location.

Under the transaction scheme of the present systems and methods, end users may have downloaded the gift transaction application from a digital distribution platform (e.g., an application store), and installed the application onto the respective clients. Using the application running on the client, each user may setup a billing profile. When at a vendor location (e.g., restaurant or retail store), the end user may check-in with the vendor location using the application. A POS system of the vendor may have been provided with another application.

In an example of a gift transaction from one end user to another end user via the application, when a first end user arrives at a restaurant for a reservation, the first end user may use the gift transaction application to check-in with the restaurant. By checking in, the application on the client of the first end user may notify other end users of a social network connected through the application that the first end user is at the restaurant. The social network may be established in the application by interfacing with another social networking platform or through a contacts list on the client. The application may be used to limit the number of other end users of the social network (e.g., ten people from family members, close friends, customers, and prospects on the social network) to which to send the notification by the first end user.

Once the first end user is seated at a table in the restaurant, a server (e.g., a waiter) may use the application on the POS system to identify and to confirm which table the first end user is seated in the restaurant. The POS system may in turn send a notification to the end users connected with the social network of the first end user. On the profile of the first end user, a green light indicator may appear to indicate to connect end users on the social network that the first end user is seated at the restaurant and is able to receive an item via the gift transaction application in real time during dining.

From the end users connected to the social network of the first end user, a second end user (e.g., a friend of the first end user) may see a notification in the gift transaction application that the first end user is at the restaurant. Via a drop down box on the application, the second end user may send the first end user a round of drinks. Once the first end user confirms receipt of the item by the second user, the order by the second end user may be sent directly to the POS system of the restaurant. When the transaction is complete and the server confirms the order on the POS system, the first end user may receive a confirmation of the transaction via a text message. The amount charged to the billing profile of the second end user may include not only the price of the item but also an automatically calculated gratuity fee and a transaction fee. The first end user may also receive a text message notifying that the billing profile of the first end user has not been charged for the item.

Subsequently, the server may take the round of drinks to the first end user, and then may use the application on the POS system to enter that the transaction has occurred, that the order is fulfilled, and that the drinks have been delivered. Upon entry on the application at the POS system, a notification may be triggered and be sent to the first end user. The transaction may be added to the newsfeed on the application for the other end users connected to the first end user via the social network. In this manner, the other end users may see that the occurrence of the transaction, in which turn may encourage other end users in the social network to buy other items for the first end user. Multiple transactions as these may occurred throughout the first end user's dining at the restaurant. With this seamless transaction process, additional outside revenue may be provided to restaurants and end users of the mutual social network may be allowed to provide gift transactions to one another, thereby further aiding the experience of the social network.

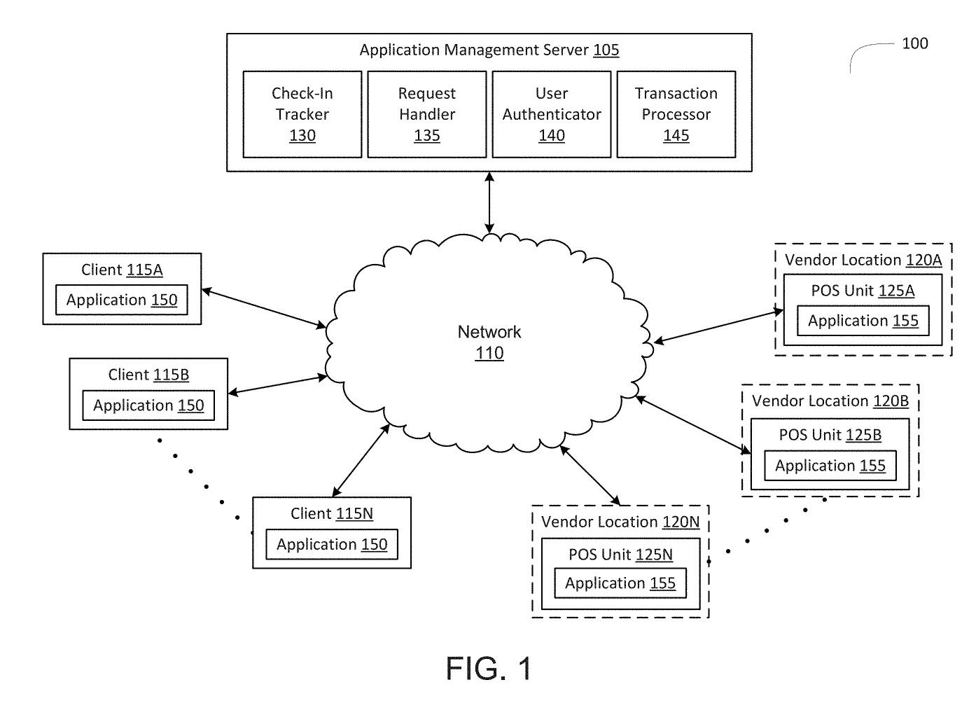

Referring first to FIG. 1, depicted is a system 100 for purchasing an item for another person via an application and point of sales systems. The system 100 may include an application management server 105, one or more clients 115A-N, and one or more point of sale (POS) units 125A-N (hereinafter generally referred to as POS unit(s) 120) connected via a network 110. The application management server 105 may include a check-in tracker 130, a request handler 135, a user authenticator 140, and a transaction processor 145, among others. Each client 115A-N may be a mobile communication device (e.g., a smartphone or tablet) and may be provided with a client-side application 150 for carrying out gift transactions. Each POS unit 125 may be any kind of payment device, such as cash registers, barcode scanners, payment terminals, or a smartphone or tablet with a payment processing application. Each POS unit 125 may be disposed in a vendor location 120A-N (hereinafter generally referred to as vendor location 120), and may be provided with a POS-side application 155 for carrying out gift transactions. In some embodiments, each POS unit 125 may interface or may be integrated with a POS system to handle payment processing for the vendor location 120. The POS system may include a server or a cloud service accessible via the network 110.

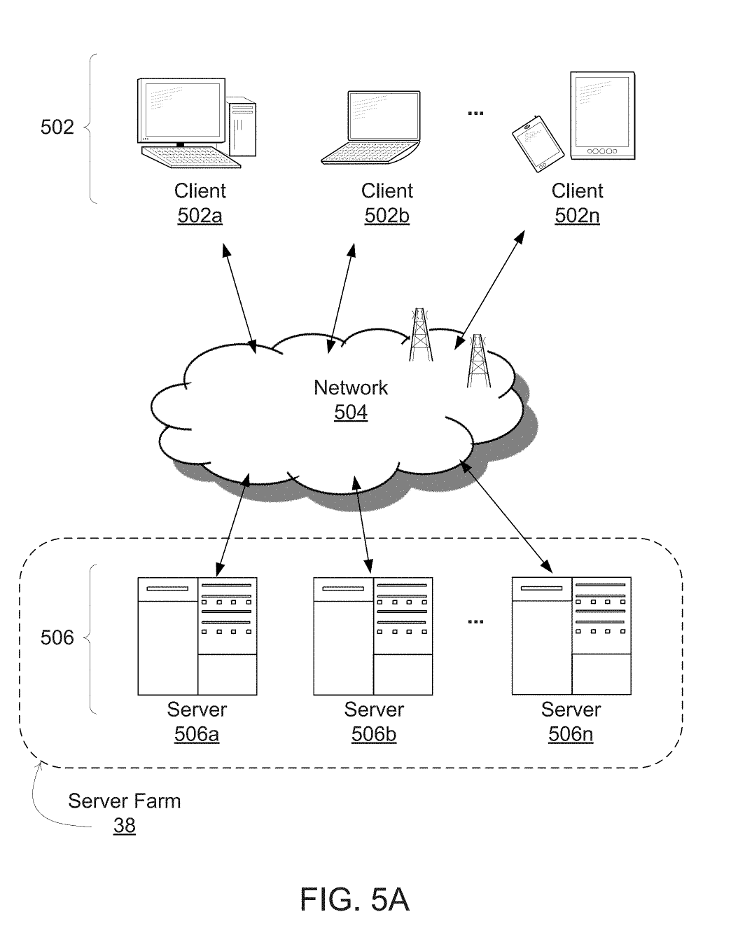

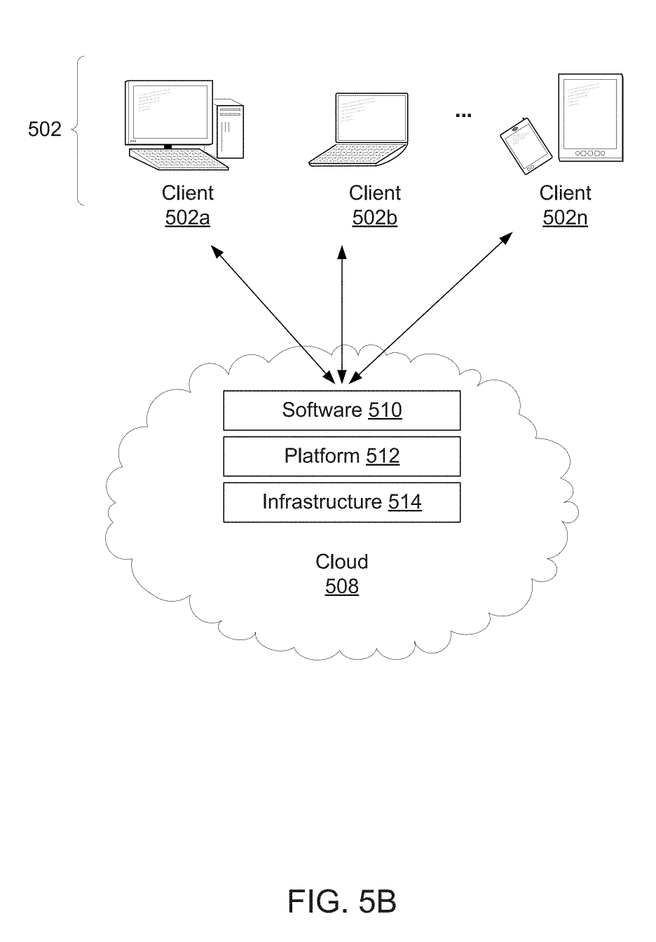

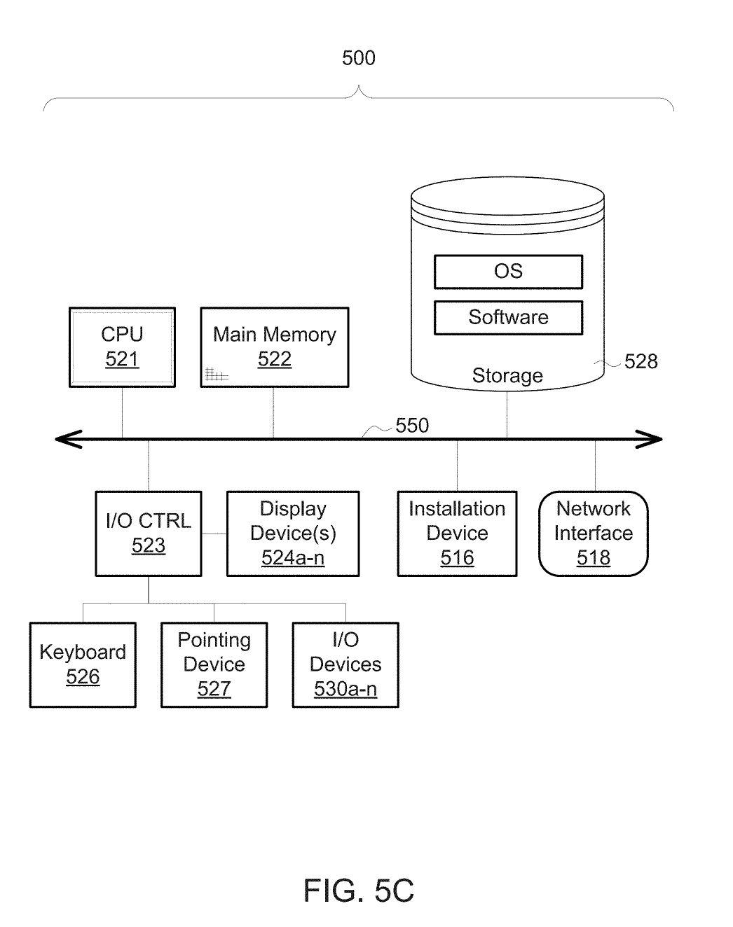

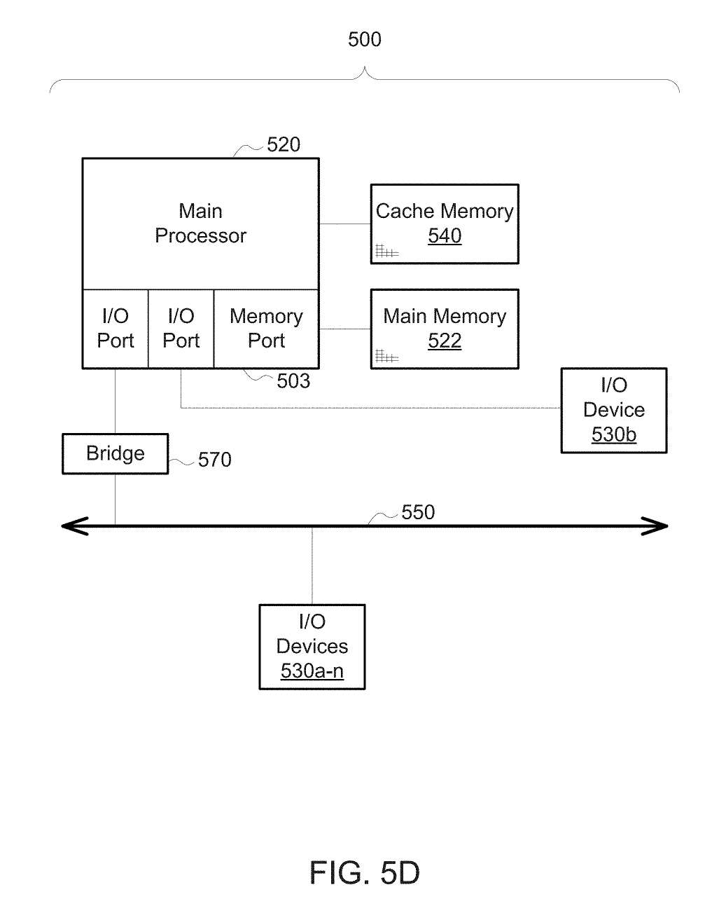

Each of the above-mentioned elements or entities is implemented in hardware, or a combination of hardware and software, in one or more embodiments. For instance, each of these elements or entities could include any application, program, library, script, task, service, process or any type and form of executable instructions executing on hardware of the system, in one or more embodiments. The hardware includes circuitry such as one or more processors, for example, as described above in connection with FIGS. 5A-5D, in some embodiments, as detailed in section B.

The clients 115A-N may be provided with the client-side application 150 to communicate with the application management server 105 to carry out the gift transactions. The client 115A-N may send a request to download the application 150 to a digital distribution platform (e.g., an app store) via the network 110. Subsequently, the client 115A-N may receive the application 150 and may install the application 150. Upon installation and execution of the application 150 on the client 115A-N, the application 150 may present an initial prompt (also referred to as a splash screen). The initial prompt may be a landing page presenting information regarding the application 150, such as the functionalities of the application 150 and interests of the end user.

Subsequent to presenting the initial prompt, the application 150 may present a prompt for the end user to login. The prompt to login may include an account number and a passcode. After a successful login, the application 150 may present a prompt for the end user (e.g., customer) to enter billing information. The billing information may include first name, last name, billing address, bank routing number, bank account number, credit card number, security code, and associated credentials, among others. In addition to the billing information, the application 150 may be used to select funding sources, such as PayPal™, Venmo™, ACHBank™, Stripe™, or a bank account, among others. The billing information may be used to create a virtual financial storage unit (also referred to as a virtual wallet). The virtual financial storage unit may store transferred fund credits in the account of one user to be sent to other end users or to vendor products or services. The application 150 may also be used by the end users to hold funds for future gift purchases. The application 150 may be provided with an application programming interface (API) particular for interfacing with the application management server 105 to access the functionalities of the application management server 105. In some embodiments, the application 150 may identify a location of the client 115A-N running the application 150 by accessing a Global Positioning Satellite (GPS) communication unit in the client 115A-N.

The POS units 125 may be provided with the POS-side application 155 to communicate with the application management server 105 to carry out the gift transactions. The POS unit 125 may send a request to download the application 155 to the digital distribution platform (e.g., an app store) via the network 110. The request may include an agreement by a vendor associated with the vendor location 120 of the POS Unit 125 with an administrator of the application management server 105. Subsequently, the POS unit 125 may receive the application 155, and may install the application 155. Upon installation and execution of the application 155 on the POS unit 125, the application 155 may present a prompt for the end user (e.g., administrator of the vendor location 120 or the POS unit 125) to login. The prompt to login may include an account number and a passcode. After a successful login, the application 155 may present a prompt to the end user of the POS unit 125 to enter billing information. The billing information may include first name, last name, billing address, bank routing number, bank account number, credit card number, security code, and associated credentials, among others. In addition to the billing information, the application 155 may be used to select funding sources, such as PayPal™, Venmo™, ACHBank™, Stripe™, or a bank account, among others. The application 150 may be provided with an application programming interface (API) particular for interfacing with the application management server 105 to access the functionalities of the application management server 105. In some embodiments, the application 155 may identify a location of the POS unit 125 running the application 155 by accessing a Global Positioning Satellite (GPS) communication unit on the POS unit 125.

When entering a vendor location 120 with a POS unit 125 provided with the POS-end application 155, a first end user may use the application 150 running on a first client 115A to notify a second end user using the application 150 on a second client 115B. The application 150 may present on the client 115A a prompt to check-in. Upon receiving a user input on the prompt to check-in, the application 150 of the first client 115A may identify a location of the first client 115A using the GPS unit thereon. Additionally, in response to the user input, the application 150 may request for locations of vendor locations 120 of POS units 125 with the application 155 to the application management server 105. Upon receipt of the locations of the other vendor locations 120 from the application management server 105, the application 150 may compare the location of the first client 115A with one or more locations of vendor locations 120. If the application 150 determines that the location of the first client 115A matches with one of the locations of the vendor locations 120 within a threshold distance, the application 150 may send a check-in notification to the application manager server 105. The check-in notification may indicate that the first end user of the first client 115A is at the vendor location 120 associated with the POS unit 125. The check-in notification may include the account identifier for the first end user of the application 150 on the first client 115A, the location of the vendor 120, among others. In some embodiments, the application 150 may further prompt the first end user at which specific area within the vendor location 120 (e.g., a seat, a table, or any other predesignated point) the first end user is located. Upon entry of the specific area within the vendor location 120, the application 150 of the first client 115A may include the specific area into the check-in notification for sending to the application management server 105.

In some embodiments, the application 155 on the POS unit 125 (or another device at the vendor location 120) may determine that the first end user of the first client 115A is at the vendor location 120. For example, the first end user of the first client 115A may check in upon arrival to the vendor location 120 using the POS unit 125 (or another device). By checking in, the POS unit 125 may generate and transmit the check-in notification to the check-in tracker 130. The check-in notification generated by the POT unit 125 may include the account identifier for the first end user of the application 150 on the first client 115A, the location of the vendor 120, the identifier corresponding to the vendor location 120, and the specific area within the vendor location 120, among others.

In turn, the check-in tracker 130 of the application management server 105 may receive the check-in notification from the first client 115A. In some embodiments, the check-in tracker 130 may receive the check-in notification from the POS unit 125 associated with the vendor location 120. The check-in notification may indicate that the first client 115A is at the vendor location 120 with the POS unit 125 provided with the POS-end application 155. The check-in tracker 130 may parse the check-in notification to identify the account identifier for the end user of the application 150 of the first client 115A. In some embodiments, the check-in tracker 130 may interface or may be integrated with one or more reservation management systems (RMS) in determining whether the end user is at the vendor location 120. The reservation management system may include, for example, OpenTable™, Reserve™, and Booking™, among others. The check-in tracker 130 may interface with the RMS via the network 110. By interfacing with the RMS, the check-in tracker 130 may access one or more calendar events of the first end user of the first client 115A to determine whether first end user is at the vendor location 120. In some embodiments, the check-in tracker 130 may maintain a timer to compare a current date and time to a date and time specified by the calendar event of the first end user. When the current date and the specified is determined to match and the current time is within a predetermined margin of the specified time, the check-in tracker 130 may determine that the first end user of the first client 115A is at the vendor location 120. In some embodiments, the check-in tracker 130 may verify that the first end user is at the vendor location 120 by receiving a check-in confirmation from the RMS. When the first end user of the first client 115A arrives at the vendor location 120, the RMS may receive the check-in confirmation from the vendor location 120 and forward the confirmation to the check-in tracker 130. Responsive to the determination, the check-in tracker 130 may also access the RMS to identify the account identifier of the first end user.

With the identification of the account identifier, the check-in tracker 130 may identify one or more other designated end users on other clients 115B-N provided with the application 150. In some embodiments, the check-in tracker 130 may access a social network using the account identifier of the first end user to identify one or more other account identifiers for other end users associated with the first end user. In some embodiments, the check-in tracker 130 may access a list of contacts for the first end user using the account identifier to identify the one or more other account identifiers for other end users associated with the first end user for the first client 115A. Once the other end users associated with the first end user are identified, the check-tracker 130 may send a notification to the applications 150 of the other clients 115B-N identified as associated with the first end user via the network 110. The notification may include the account identifier for the first end user, the contact information for the first end user, and information related to the vendor location 120 and the POS unit 125. The information related to the vendor location 120 and the POS unit 125 may be used to carry out a transaction. In some embodiments, the check-in tracker 130 may add an indication (e.g., a colored tag) that the first end user of the application 150 on the first client 115A onto a social network page associated with the first end user. The indication may be a graphical user interface element. Interaction with the indication may cause the application 150 on the respective client device 115B-N to retrieve the account identifier for the first end user, the contact information for the first end user, and information related to the vendor location 120 and the POS unit 125. The information related to the vendor location 120 may include a vendor identifier, a physical address for the vendor, contact information of the vendor, billing information for the vendor, and identifier for the POS unit 125, among others. In some embodiments, the information may also include one or more items offered by the vendor (e.g., types of products or services) and a price for each item, among others.

Upon receiving the notification from the check-in tracker 130, the application 150 at each client 115B-N may present the notification to the respective end user. The presentation of the notification may include a visual prompt (e.g., pop-up message, a dialog box, a push notification, etc.), and an audio message (e.g., vibration, media file, etc.), among others. At least one end user (also referred to as the “giftor”) on the application 150 on a second client 115B may respond to the notification to initialize the gift transaction. In some embodiments, interaction with the notification or opening the application 150 in response to the notification may cause the application 150 on the second client 115B to display a prompt for initiating a gift transaction. The prompt for initiating a gift transaction may include a graphical user interface element for each item offered by the vendor of the vendor location 120 and a price for the corresponding item. In some embodiments, the prompt may include a graphical user interface element to commence the transaction. The second end user of the second client 115B may use the graphical user interface element of the application 150 to select one or more items to gift to the first end user (also referred to as the “giftee”) of the first client 115A. In selecting the one or more items, the prompt for initiating the gift transaction running on the application 150 of the second client 115B may provide a total transaction amount for the gift. The total transaction amount may be calculated by the application 150 on the second client 115B, and may be a sum of the price for each selected item, a transaction fee, and an automatically calculated gratuity fee, among other factors. In some embodiments, the application 150 may also indicate the constituent values of the selected items, transaction fee, and the gratuity fee separately for the total transaction amount.

In some embodiments, the graphical user interface may be specific or particular to a vendor location 120. The graphical user interface for the prompt may be customized, selected, or otherwise configured via the check-in tracker 130 of the application management server 104 by an administrator associated with the vendor location 120. The graphical user interface may include one or more items to gift (e.g., goods or services), notification method (e.g., notification via email, text message, or through the application 150), and payment options (amount of payment, coupons, gift card), among others. For example, the vendor location 120 may be a tavern serving food and beverages. The graphical user interface for the tavern may include options for food or beverage items (e.g., hamburgers, hotdogs, and beer) and options for payment amount (e.g., quarter, half, or full amount), with which the giftor can select for the giftee. In another example, the vendor location 120 may be for a retail store (e.g., selling sports goods). The graphical user interface may include options for various goods (e.g., tennis rackets, footballs, or servicing of snowboard) and payment options (e.g., gift card for a certain amount or a coupon on select goods).

When there is an interaction with the graphical user interface element to commence the transaction, the application 150 of the second client 115B may send a request for initiating gift transactions to the application management server 105 via the network 110. In some embodiments, the application 150 of the second client 115B may generate the request for initiating the gift transaction. The request for initiating the gift transaction may include the account identifier for the first end user of the first client 115A, an account identifier for the second end user of the second client 115B, the information related to the vendor of the vendor location 120, the one or more selected items, and the total transaction amount for the gift transaction, among other. In some embodiments, the application 150 of the second client 115B may also generate a transaction identifier to include in the request.

Subsequently, the request handler 135 of the application management server 105 may receive the request for initiating the gift transaction from the application 150 of the second client 115B. The request handler 135 may parse the request for initiating the gift transaction to identify the account identifier for the application 150 of the first client 115A, the account identifier for the second end user of the second client 115B, the information related to the vendor of the vendor location 120, the one or more selected items, the total transaction amount for the gift transaction, and the transaction identifier, among others. Using the request for initiating the gift transaction, the request handler 135 may generate a gift offer message (sometimes referred herein also as a request for initiating the gift transaction) for the first end user of the first client 115A. The gift offer message may include the same contents as the request for initiating the gift transaction received from the second client 115B. The gift offer message may include the account identifier for the first end user of the first client 115A, the account identifier for the second end user of the second client 115B, the information related to the vendor of the vendor location 120, the one or more selected items, the total transaction amount for the gift transaction, and the transaction identifier, among others. The request handler 135 may transmit the gift offer message to the application 150 of the first client 115A. In some embodiments, the request handler 135 may forward the request to initiate from the second client 115B to the first client 115A as the gift offer message.

After receiving the gift offer message, the application 150 of the first client 115A may present a prompt for accepting the gift transaction. The prompt may include a graphical user interface element for acceptance and another element for rejection. If the gift offer is rejected by the first end user by interacting with the graphical user interface element for rejection, the application 150 on the first client 115A may transmit a rejection notification to the request handler 135. The request handler 135 in turn may forward the rejection notification to the application 150 of the second client 115B, and no gift transaction may be processed. Conversely, if the gift offer is accepted by the first end user by interacting with the graphical user interface element for acceptance, the application 150 on the first client 115A may generate an acceptance notification. In some embodiments, the application 150 on the first client 115A may generate the acceptance notification in accordance to the API. The acceptance notification may include contents of the gift offer message. The acceptance notification may include the account identifier for the first end user of the first client 115A, an account identifier for the second end user of the second client 115B, the information related to the vendor of the vendor location 120, the one or more selected items, and the total transaction amount for the gift transaction, among others. Once generated, the application 150 of the first client 115A may transmit the acceptance notification to the application manager server 105 via the network 110. The request handler 135 in turn may forward the acceptance notification to the application 150 of the second client 115B and to the application 155 on the POS unit 125 at the vendor location 120. In some embodiments, the request handler 135 may insert an address (e.g., a Uniform Resource Locator (URL)) for initiating a connection to process the gift transaction into the acceptance notification, prior to forwarding to the application 150 of the first client 115A.

With the acceptance of the gift offer from the second end user by the first end user, the user authenticator 140 of the application management server 105 may initiate authentication with the application 150 of the second client 115B. In some embodiments, the user authenticator 140 may initiate the authentication with the second client 115B in response to the receipt of the request to initiate the transaction from the client 115B, without or independent of the acceptance by the first end user of the first client 115A. In response to the receipt of the acceptance notification, the application 150 of the second client 115B may establish a connection with the user authenticator 140 via the network 110. In some embodiments, the connection with the user authenticator 140 may be established in accordance to an encryption protocol (e.g., asymmetric or public key cryptography, message authentication code, symmetric-key algorithm, and stream cipher, etc.). In some embodiments, the application 150 of the second client 115B may generate a client key (e.g., public key) and a private code. The generation of the client key and the private code may be based on the contents of the acceptance notification. In some embodiments, the application 150 of the second client 115B may parse the acceptance notification to identify the address to initiate the connection to process the gift transaction. The address may correspond to the user authenticator of the application management server 105. Using the provided API, the application 150 of the second client 115B may perform a handshake procedure with the user authenticator 140 at the address identified in the forwarded acceptance notification. The handshake procedure may be in accordance to any communication protocol (e.g., Simple Mail Transfer Protocol (SMTP) and Transport Layer Security (TLS), among others). In performing the handshake procedure, the application 150 of the second client 115B may pass the generated client key and the private code to the user authenticator 140. When the handshake procedure is successfully performed, the user authenticator 140 may authenticate the application 150 of the second client 115B.

Upon completion of the authenticating the application 150 of the second client 115B, the transaction processor 145 of the application management server 105 may proceed to gather information for processing the gift transaction between the first end user and the second end user. Subsequent to successfully performing the handshake procedure, the application 150 of the second client 115B may generate transaction data. The transaction data generated by the application 150 may include the account identifier for the second end user of the second client 115B, billing information for the second end user, the total transaction amount for the gift transaction, and the transaction identifier, among others. In some embodiments, the application 150 of the second client 115B may generate the transaction data using a predefined format specified by the application programming interface (API). The transaction data generated by the application 150 may, for example, be of the form:

{user_id} {user_first_name} {user_last_name} {user_email}
{purchase_price} {purchase_transaction_id}

Once generated, the application 150 of the second client 115B may send the transaction data via the connection established with the application management server 105 through the network 110. In some embodiments, the application 150 of the second client 115B may send the transaction data as part of the handshake procedure.

The transaction processor 145 may then receive the transaction data from the application 150 of the second client 115B. The transaction processor 145 may in turn parse the transaction data received from the application 150. Using the transaction data, the transaction processor 145 may identify the application 155 of the POS unit 125 at the vendor location 120. The transaction processor 145 may establish a connection with the application 155 via the network 110. In some embodiments, the connection with the transaction processor 145 may be established in accordance with an encryption protocol (e.g., asymmetric or public key cryptography, message authentication code, symmetric-key algorithm, and stream cipher, etc.). The transaction processor 145 may send a request to establish connections to the application 155 of the POS unit 120 via the network 110. The request may include an address corresponding to the transaction processor 145 and data to carry out the establishing of the connection in accordance with the encryption protocol. The application 155 of the POS unit 120 may in turn parse the request to identify the address to initiate the connection to process the gift transaction. Using the provided API, the application 155 of the POS unit 120 may perform a handshake procedure with the transaction processor 145. The handshake procedure may be in accordance to any communication protocol (e.g., Simple Mail Transfer Protocol (SMTP) and Transport Layer Security (TLS), among others). When the handshake procedure is successfully performed, the transaction processor 145 may authenticate the application 155 of the POS unit 120.

Upon the application 155 of the POS unit 120 has finished authenticating with the transaction processor 145, the transaction processor 145 of the application management server 105 may proceed to process the gift transaction between the first end user and the second end user. Subsequent to successfully performing the handshake procedure, the transaction processor 145 may forward the transaction data generated by the application 150 of the second client 115B. As discussed above, the transaction data may include the account identifier for the second end user of the second client 115B, billing information for the second end user, the total transaction amount for the gift transaction, and the transaction identifier, among others. In some embodiments, the transaction processor 145 may insert a success return path and a failure return path into the transaction data to be forwarded to the POS unit 120. The success return path may correspond to an address to which to send a response indicating a success in completing the gift transaction. The failure return path may correspond to an address to which to send a response indicating a failure to complete the gift transaction. In some embodiments, the transaction processor 145 may maintain the transaction data using a predefined format specified by the application programming interface (API). The transaction data may, for example, be of the form:

{user_id} {user_first_name} {user_last_name} {user_email}
{purchase_price} {purchase_transaction_id}
{success_return_path} {failure_return_path}

Once generated, the transaction processor 145 may send the transaction data via the connection established with the POS unit 120 through the network 110. In some embodiments, the transaction processor 145 may send the transaction data as part of the handshake procedure.

Afterwards, the application 155 of the POS unit 125 at the vendor location 120 may receive the transaction data from the transaction processor 415. The application 155 may parse the transaction data to identify the account identifier for the second end user of the second client 115B, billing information for the second end user, the total transaction amount for the gift transaction, the transaction identifier, the success return path, and the failure return path, among others. Using the transaction data, the application 155 may proceed to complete the transaction with a payment processing service (e.g., PayPal™, Stripe™, Authorize.Net™, etc.). The payment processing service may be a separate server connected to the network 110, and may interface with the application 155 on the POS unit 120. In proceeding to complete the transaction, the application 155 on the POS unit 120 may forward the transaction data to the payment processing service. The payment processing service in turn may carry out the transaction using the transaction data to charge the total transaction fee against an account of the second end user. If the transaction can be successfully completed, the vendor associated with the vendor location 120 may be charged the transaction amount by the payment processing service. The payment processing service may then return a response indicating success or failure in completing the gift transaction.

The application 155 of the POS unit 125 may then receive the response from the payment processing service. The application 155 may parse the response to identify whether the processing of the gift transaction was successful. If the response indicates failure, the application 155 of the POS unit 125 may forward the response to the transaction processor 145. In some embodiments, the application 155 may forward the response to the address indicated in the failure response path of the transaction data. The transaction processor 145 may in turn forward the response to the application 150 of the second client 115B. In response to the receiving the response indicating failure, the application 150 of the second client 115B may present a prompt indicating failure. In addition, the application 150 of the second client 115B may also present a prompt for whether to attempt the gift transaction action again. Upon interacting with the prompt, the application 150 and the application management server 105 may repeat the functionalities as detailed previously in processing the gift transaction.

On the other hand, if the response from the payment processing service indicates success, the application 155 of the POS unit 125 may present a prompt indicating success. The prompt may also instruct an end user of the POS unit 125 (e.g., a waiter, server, or another employee at the vendor location 120) to supply the selected one or more products or to perform the selected one or more services as requested by the second end user of the second client 115B. Subsequently, the end user of the application 155 of the POS unit 125 may interact with the prompt to indicate the completion of the provision of the selected product or the performance of the selected service. In response, the application 155 of the POS unit 125 may send a completion notification to the transaction processor 145 via the network 110. The completion notification may indicate that the selected product was provided or that the selected service was performed for the first end user. The transaction process 145 may in turn forward the completion notification to the application 150 of the second client 115B of the second end user that initially made the request to perform the gift transaction.

In this manner, the application management server 105, the applications 150 running on clients 115A-N, and the applications 155 running on the POS units 125 may enable and facilitate remote transactions for one end user on behalf of another end user. The indication that one of the end users is present at the vendor location 120 to another end user via the graphical user interface of the application 150 to another end user may eliminate having both end users be physically present at the vendor location 120 to complete the transaction. In addition, by establishing an encrypted communication channel, potentially sensitive transaction data may be securely exchanged and transferred over multiple devices across the network 110.

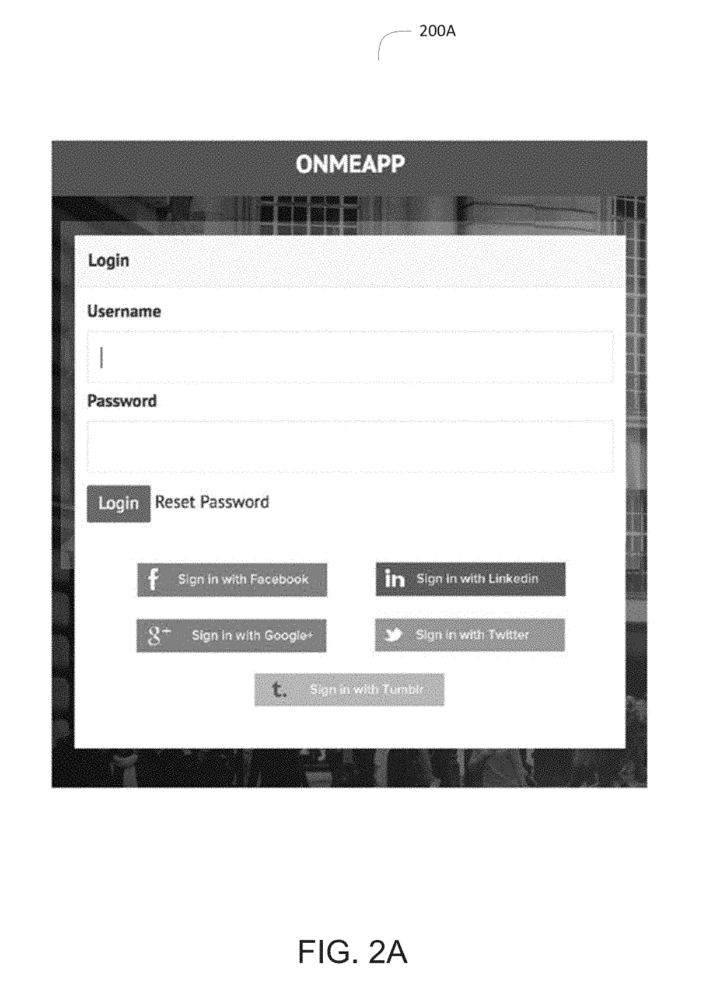

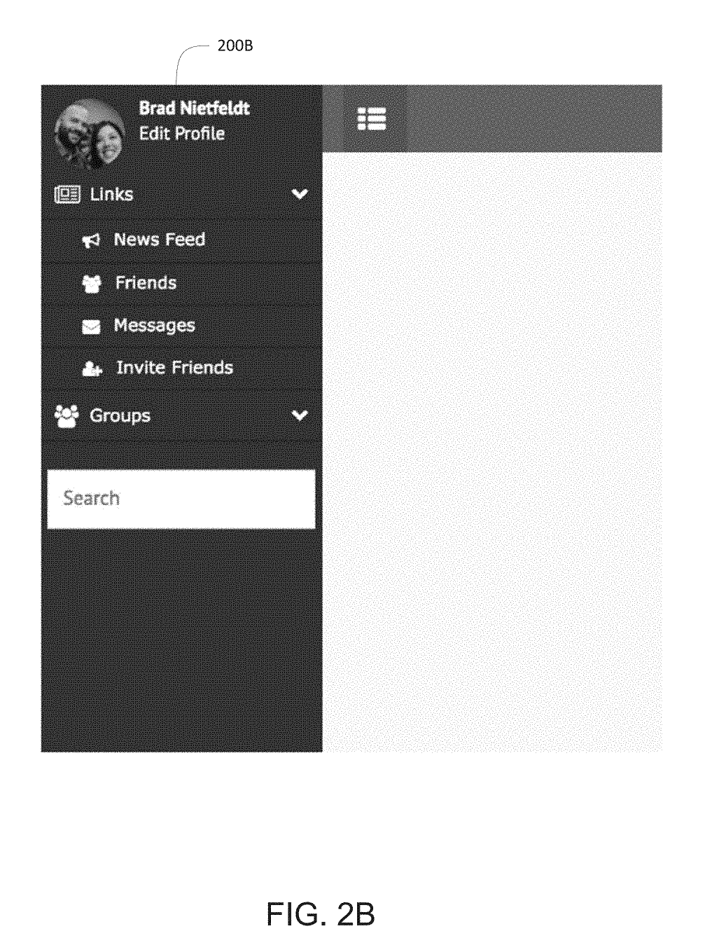

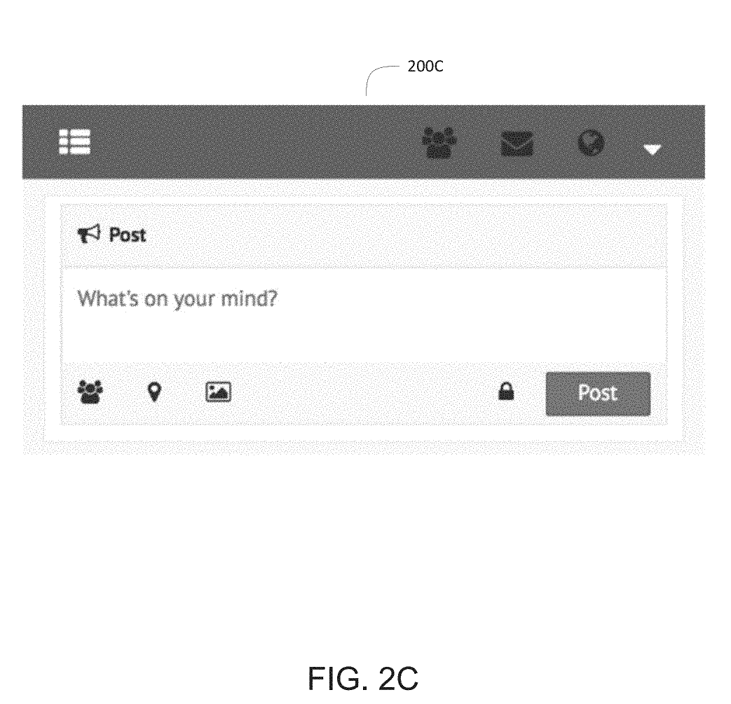

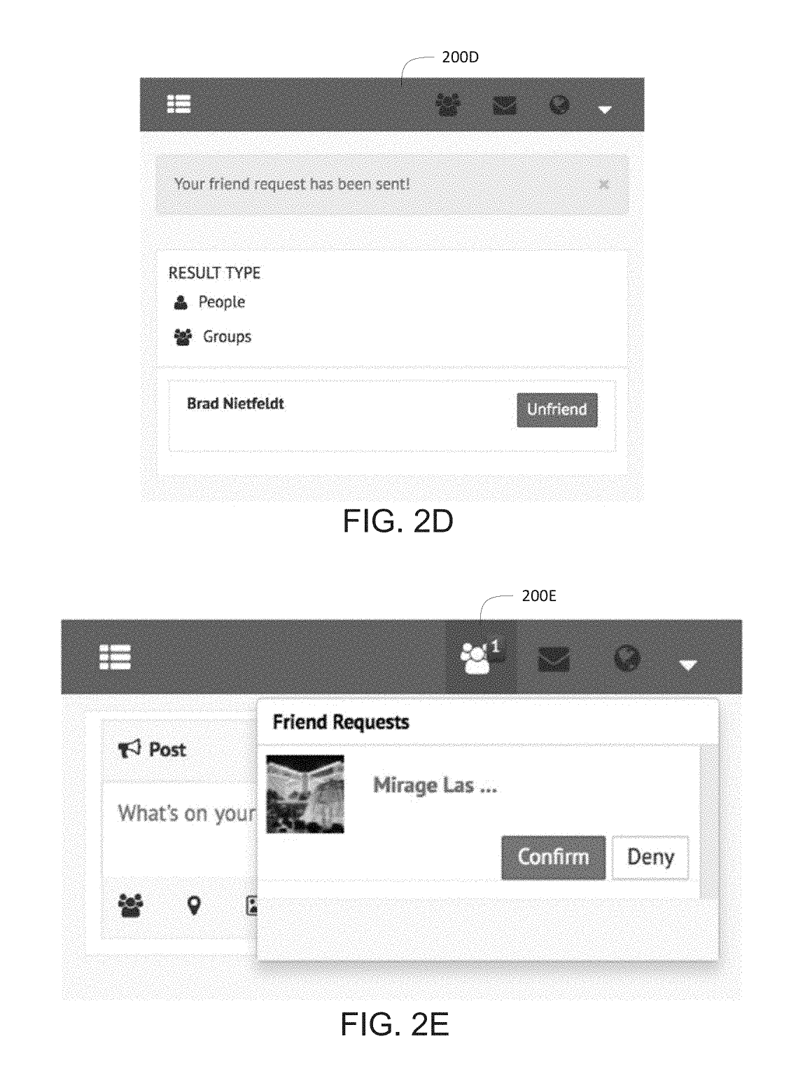

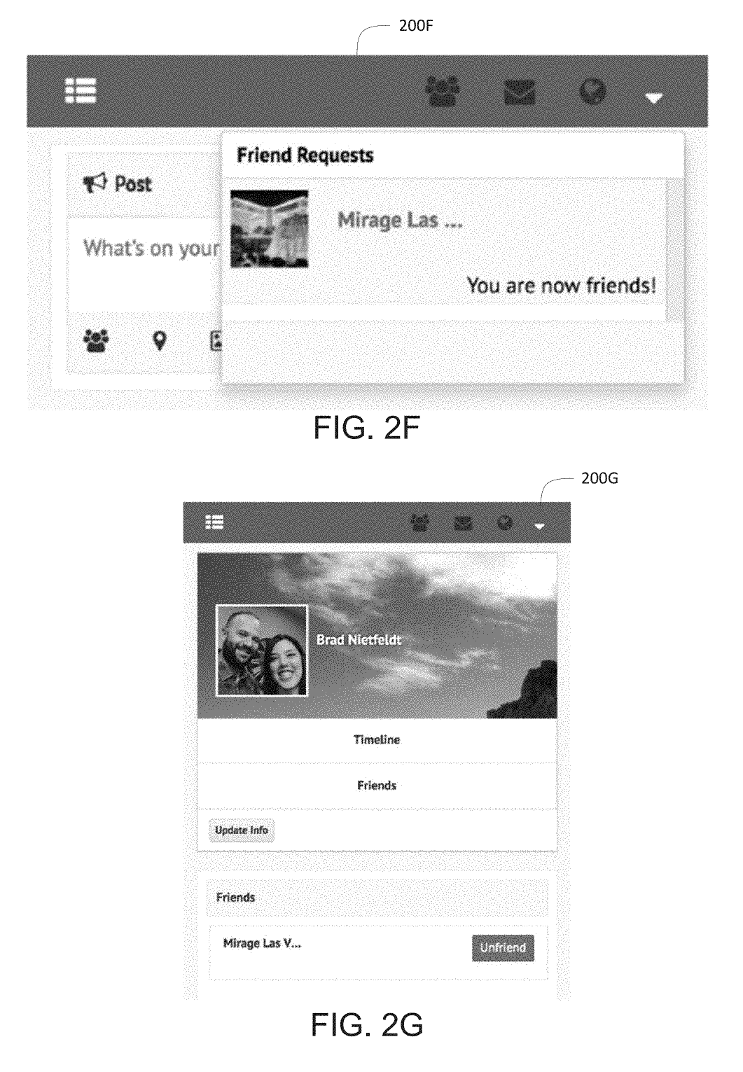

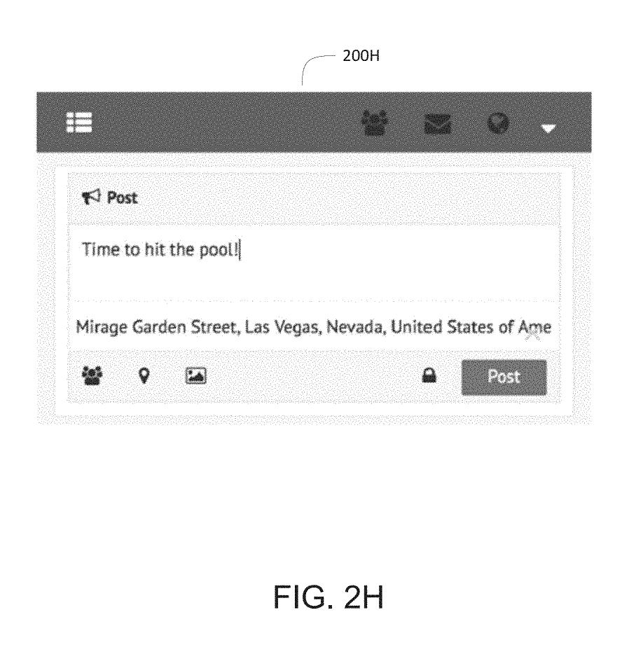

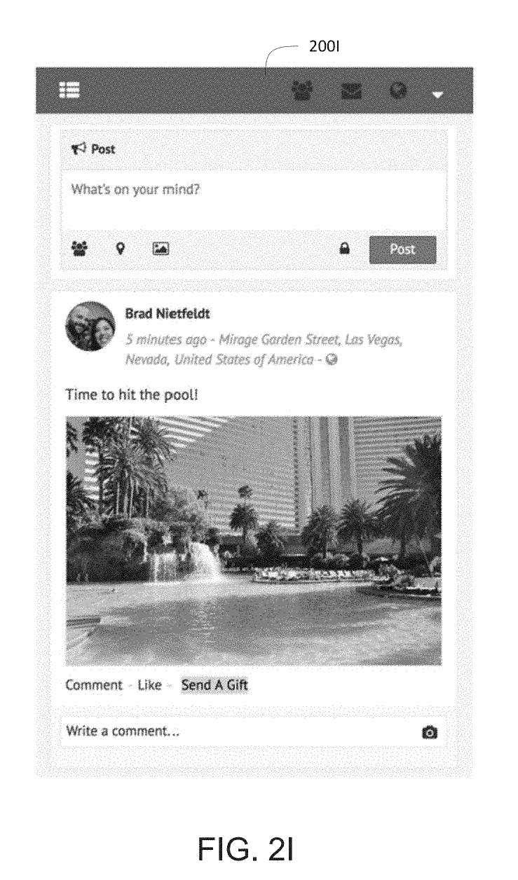

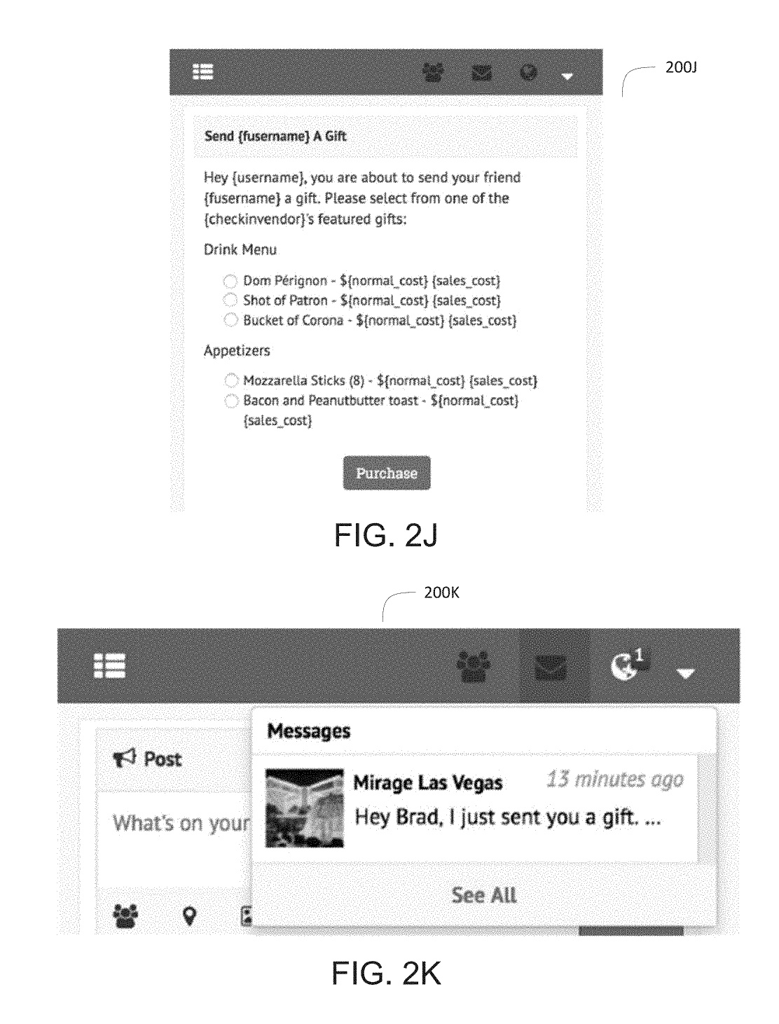

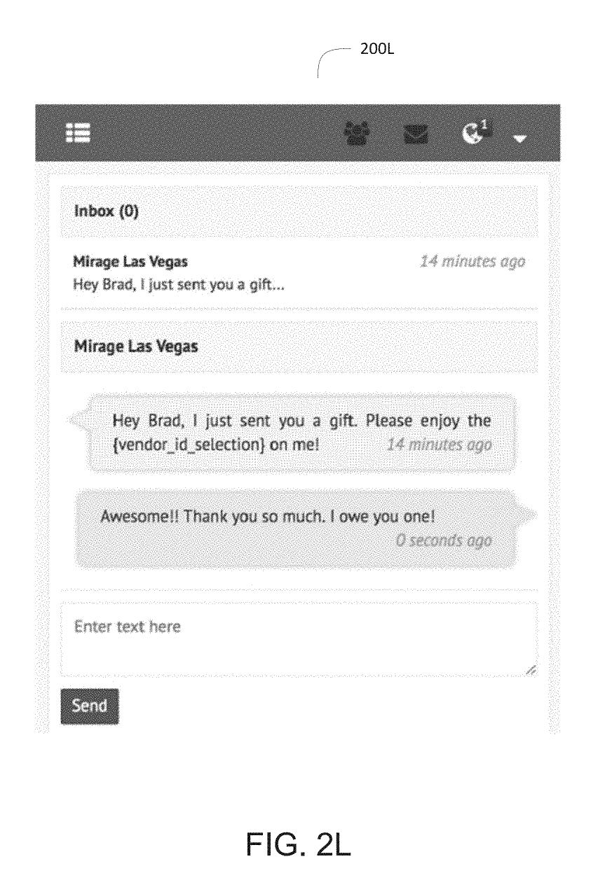

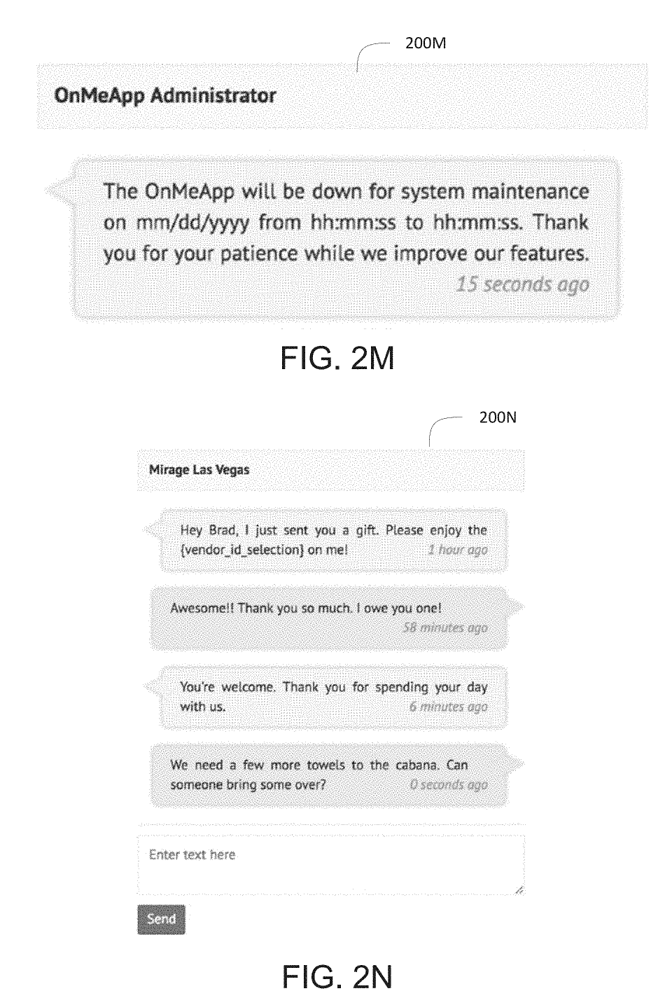

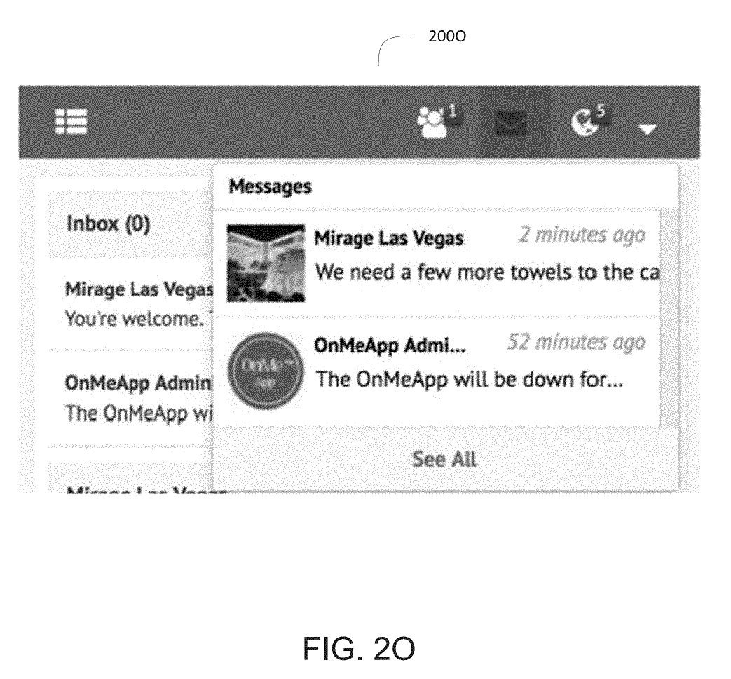

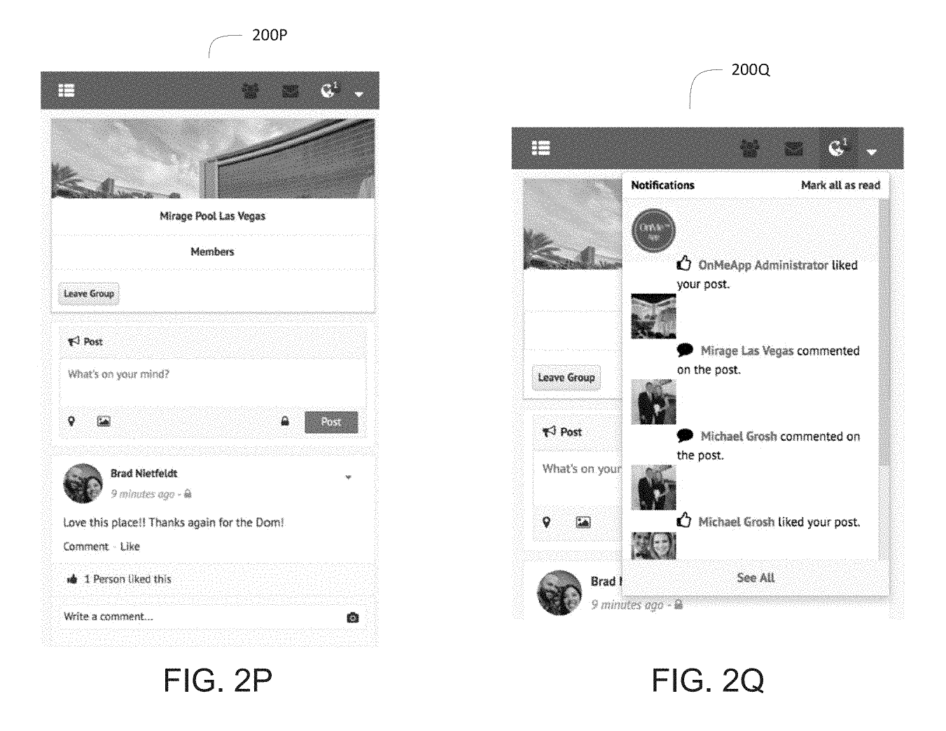

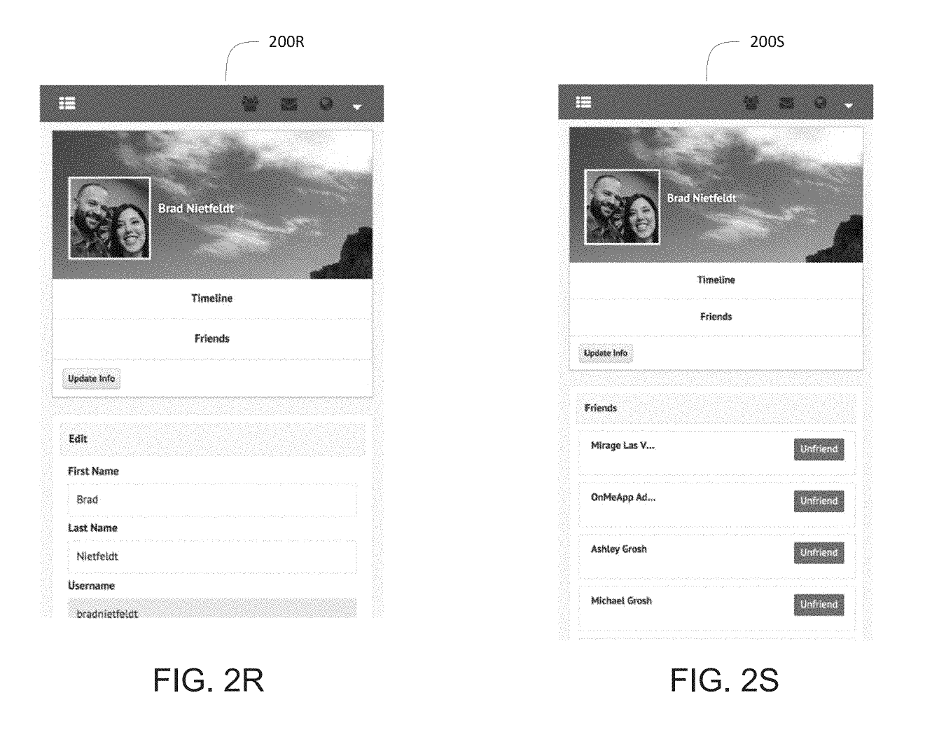

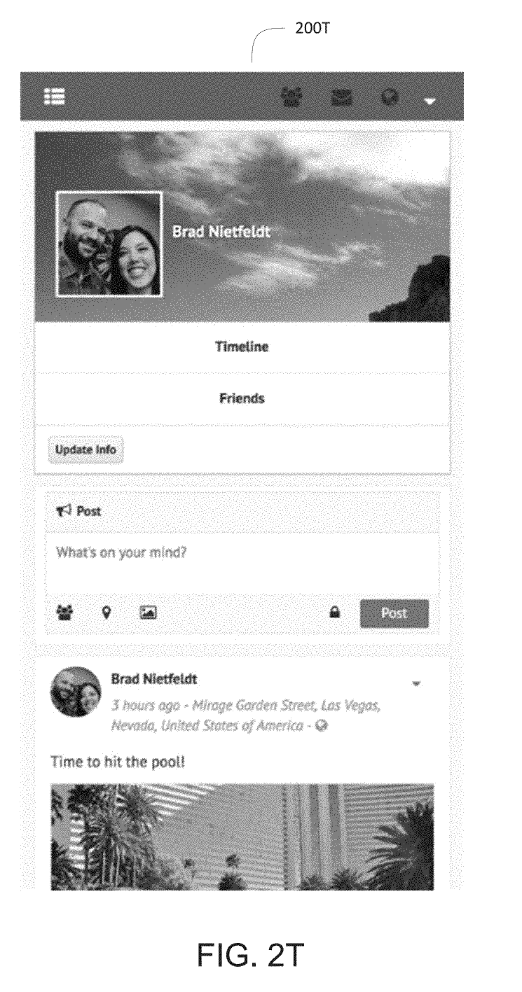

Referring now to FIGS. 2A-2T, depicted are screenshots of graphical user interfaces (GUIs) of an end-user application 150. First referring to FIG. 2A, depicted is a screenshot of a login page 200A of the end-user application 150. The login page 200A may include GUI elements for entering username and password, for resetting password, and for logging in using a social network platform. The login page 200A may include a forgotten password button to send the end user a code to reset the password. The password may be sent via email or text message. An end user of the application 150 may create custom accounts or automatically create account using social network platforms (e.g., Facebook™, Google™, or Twitter™). If a user creates an account via a social network platform, the application 150 may retrieve default account information (e.g., first name, last name, email address, etc.) from the selected social network platform. Multiple existing accounts with social network platforms may be used to sign in. The application 150 may also retrieve any other information that the account identifier matches to or that the end user has allowed the social network to share via privacy settings. To signup, default input fields may include name, email, password, password confirmation, terms and condition agreement, and phone number, among others. Upon successful authentication, a member dashboard for the end user may be displayed by the application 150. The member dashboard may increase an activity feed and other account information. On the member dashboard, default options may include network updates, view or edit profile, browse members, manage buying or selling of items, invitation of contacts, view members online, view newest members, view popular members, view new member feed, among others. The activity feed may also include advertisements.

Next referring to FIG. 2B, depicted is a screenshot of a user navigation menu 200B of the application 150 generally appearing along the left. The navigation menu 200B may include a listing of the features of the application 150, such as a newsfeed, a friend from the social network, internal messaging (notifications), groups of contacts, and a search feature, among others. Referring now to FIG. 2C, shown is a screenshot of a newsfeed page 200C of the application 150. When the end user checks in, the newsfeed page 200C may be used to update an activity feed with a location, one or more images, associative tags of members in the social network, among others, posted by the end user such that others in the social network can see. The newsfeed 200C of the application 150 may also present or house any sponsor content from affiliated vendors, advertisers, or other partner.

Now referring to FIGS. 2D-2G, depicted are screenshots of various GUIs in requesting a connection with another end user for gift transactions. First referring to FIG. 2D, a connection request window 200D of the application 150 may be used to initiate and send out an invitation to connect to the selected end user. Then, referring to FIG. 2E, a connection notification window 200E of the application 150 may be displayed to indicate to the selected end user that the end user has received a request to connect. With the connection notification window 200E, the end user may confirm or deny the request. Next, referring to FIG. 2F, the end user that initially send out the invitation to connect may be informed using a confirmation window 200F of the application 150. As depicted, the confirmation window 200F may indicate that the end user has accepted the invitation to connect. Subsequently, referring to FIG. 2G, a name corresponding to the end user that accepted the request may appear in a list of contacts in an end user profile window 200G of the end user that initially made the request to connect.

Now referring to FIGS. 2H-2L, depicted are screenshots of various GUIs in posting and checking in. First, referring to FIG. 2H, using a post window 200H of the application 150, the end user may update the status and notify other end users in the social network when the end user is and what the end user is doing. The status may include text content, image content, video content, or audio content, among others. Having posted, referring to FIG. 2I, an activity feed window 200I of the application 150 may display the status inputted by the end user. Other end users in the social network may also have a GUI element (e.g., a button labeled “Send A Gift”) to initiate a gift transaction with the end user that inputted the status. Once the gift transaction has been initiated, referring to FIG. 2J, a gift selection window 200J of the application 150 may be used to select or input which products or services (e.g., various drink and food items of the restaurant) for the particular location to give as a gift to the recipient end user. After the purchase for the gift transaction has been made, referring to FIG. 2K, the application 150 of the recipient end user may display a gift notification window 200K. The gift notification window 200K may indicate that a gift has been sent and may identify the sender of the gift. Upon interacting with the gift notification window 200K, referring to FIG. 2L, the application 150 may open up a message window 200L to reply to the gift offer and to send a text message to the sender end user. If the gift option is not available at the location of the recipient end user, the application 150 may be used to hold funds within a dedicated account for future purchases or transferred to the recipient end user. The application 150 may be also used to send the currency amount to the recipient end user as part of the gift transaction.

Now referring to FIG. 2M-2O, depicted are screenshots of various GUIs in notification of messages. The application 150 may allow end users to send messages to one another via an internal messaging system. The internal messaging system may show any network update that has happened to contacts or anyone else associated with the account of the end user. When there is an alert, an alert indicator (e.g., a box) may have a number of alerts and may be in a different style (e.g., bolding) and be in a different color. When clicked, the end user may view the alert notification within the application 150. Once the alert is viewed, the alert indicator may be un-highlighted or the end user may mark the alert as read or un-read. The internal messaging system may be an interactive chat system allowing for end users to communicate with one another. The internal messaging system may also act as a notification system for system administrators, vendors, and vendor locations, among others. First, referring to FIG. 2M, depicted is an administrator notification prompt 200M that may be shown by the application 150 via the internal messaging system. Then, referring to FIG. 2N, shown is a user-to-user messaging window 200N that may be presented by the application 150 via the internal messaging system. The end user may compose a message to send to contacts within the application 150. The message may contain attachments, and may include fields such as send to, subject, and message. Referring now to FIG. 2O, the application 150 may be used to interface with external messaging services, such as the messaging services of Facebook™ and Twitter™, and the messages from the external messaging services may be presented via a messaging window 200O.

Now referring to FIG. 2P, depicted is a screenshot of a group page 200P for the application 150. The group page 200P of the application 150 may allow end users to create, post, comment to, and read from interest-specific forums and groups. With the group page 200P, the end users may create public groups or private groups allowing other end users to join upon request. Vendors may also create groups to allow for direct communication with a multitude of end users that have joined the group. Vendor partner or sponsored group administrators may broadcast messages regarding products and services offered at associated venues using the groups. User groups created by end users may be used to coordinate members for various events.

Referring now to FIG. 2Q, depicted is a screenshot of a notification page 200Q of the application 150. The notification system of the application 150 may allow users to see activity in real-time and stay up-to-date with the statuses posted by other end users in the social network. Notifications and messages may be sent via the application 150, short message service (SMS) text message, or by a push notification, among others. Sponsored events, system notifications, and other administration notifications may be sent through the notification system of the application 150 and may be displayed on the notification page 200Q.

Referring now to FIGS. 2R-2T, depicted are screenshots of various GUIs in connection with account settings for an end user of the application 150. Referring first to FIG. 2R, shown is a screenshot of an account settings window 200R of the application 150. Using the account settings window 200R, an end user may control various aspects of the account, such as information that other end users in the same social network, transaction history, and managing connections and feed activity, among others. Referring now to FIG. 2S, depicted is a screenshot of a connection management window 200S of the application 150. Using the connection management window 200S, the end user may keep track and manage connections. Referring now to FIG. 2T, depicted is a screenshot of an activity feed management window 200T. Using the activity feed management window 200T, the end user may keep track and manage posts onto the activity feed, such as editing or deleting posts or changing a privacy of the posts.

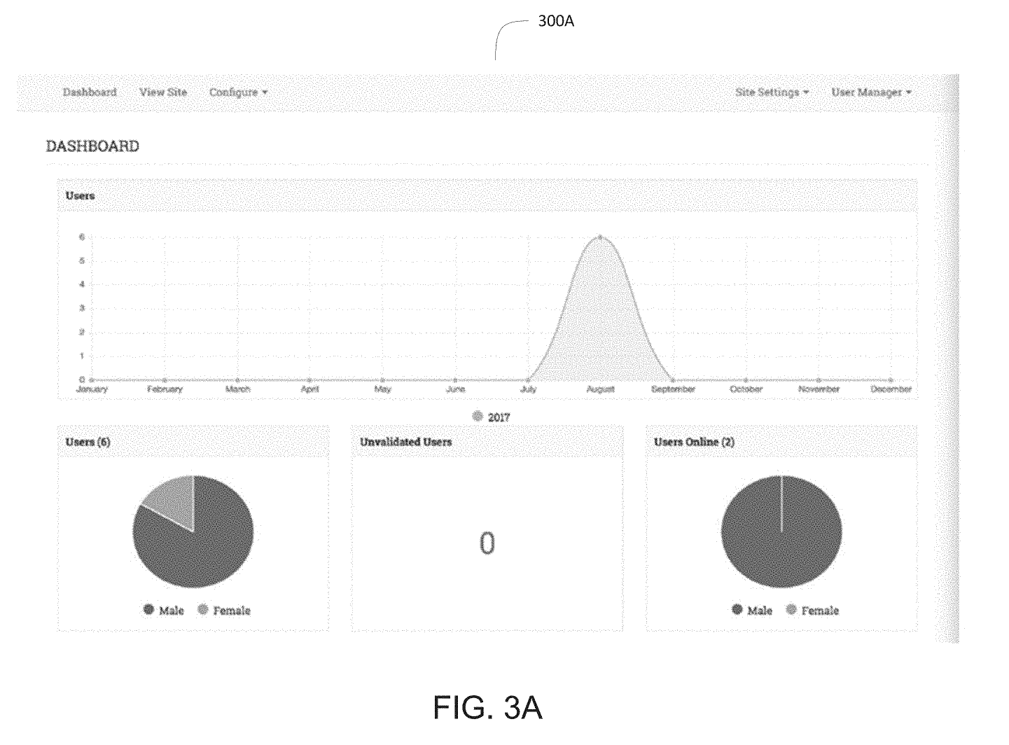

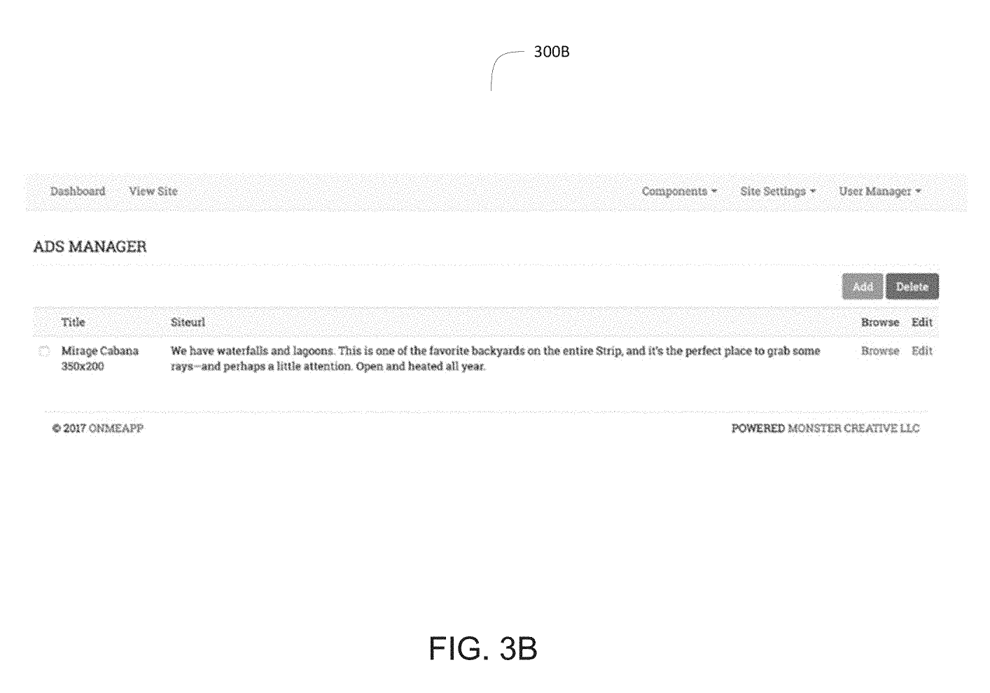

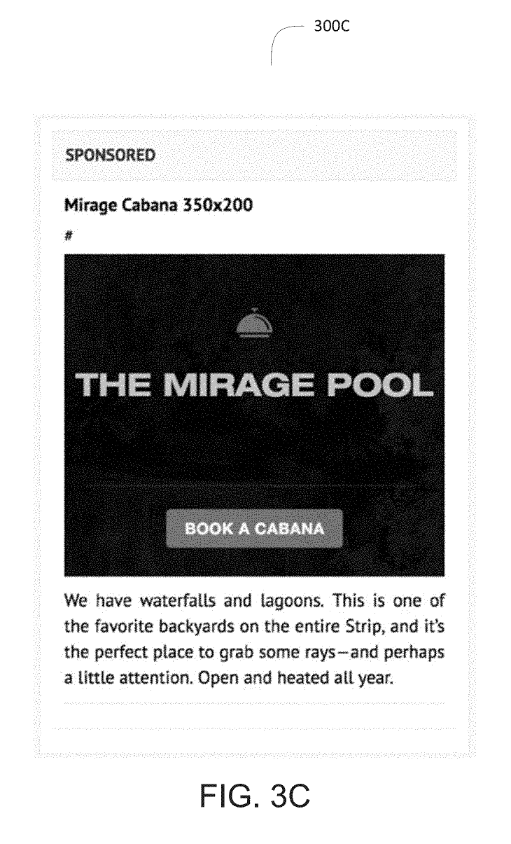

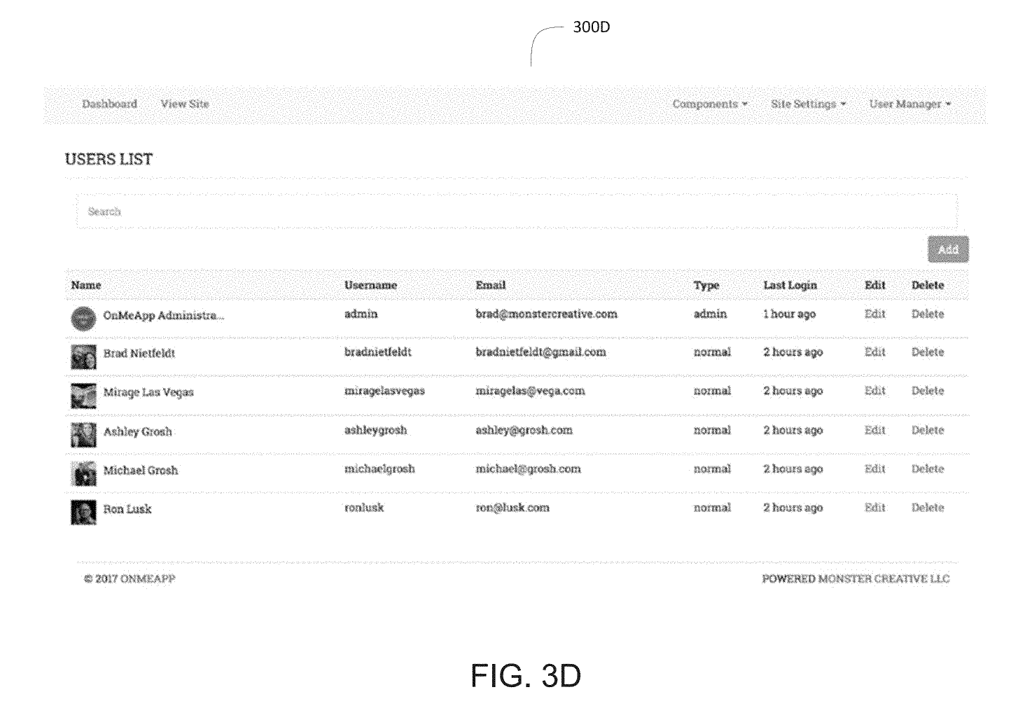

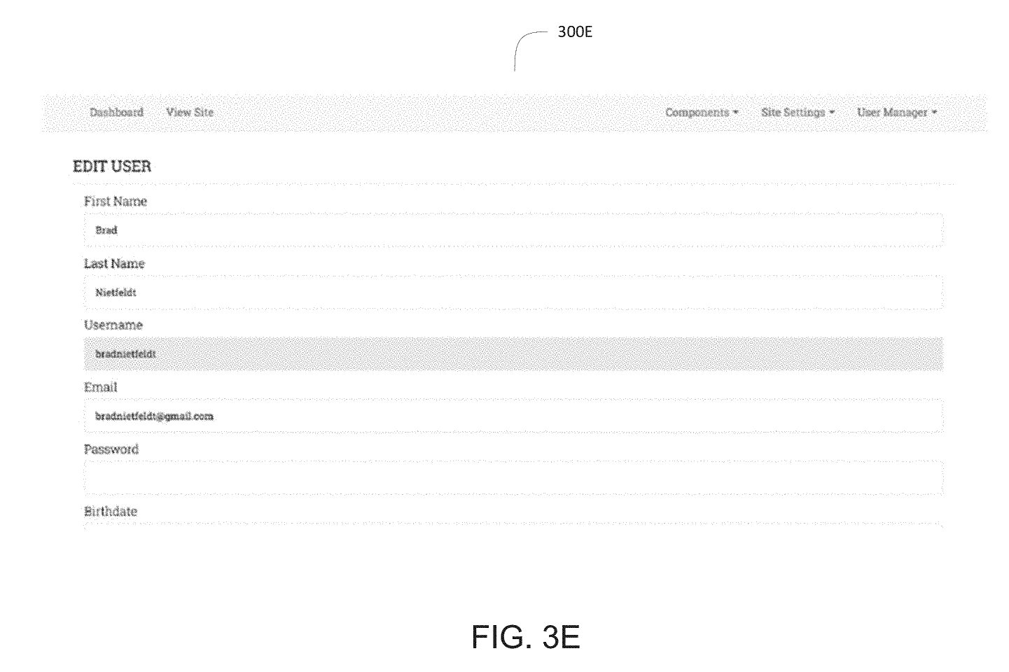

Referring now to FIGS. 3A-3E, depicted are screenshots of graphical user interfaces (GUIs) of an advertising platform of the POS-end application 155. In some embodiments, the advertising platform may be available to an advertiser associated with a vendor of the vendor location 120 with the POS unit 125. Referring first to FIG. 3A, depicted is a dashboard 300A of the advertising platform. The dashboard 300A may be a web-based administrative GUI for displaying statistics of application usage and any other statistical data for the administrator. The dashboard 300A of the advertising platform may include predictive analytics to allow the administrator to have insight over employee productivity and staffing to measure against established protocols.

Referring now to FIG. 3B, depicted is an administrative management GUI 300B. Using the administrative management GUI 300B, the administrator may create and view statistics on advertising zones and manage advertisements placed within the zones throughout the application 150. Each advertising zone may correspond to an area of the activity feed displayed by the application 150. The advertisements may be syndicated from other advertising networks or from sponsored vendors' partners. Referring now to FIG. 3C, depicted is an example of an advertisement 300C to be displayed in an activity feed of the application 150. The administrative management GUI 300B may include a component manager for modifying the inner working features of the application 150 or 155. Using the component manager, the administrator may build new features into the overall framework of the application 150 or 155 or an advertising campaign, and may access controls to govern how end users interact with the feature. Components may, for example, include account settings, newsfeed, status update photos, check-in, group memberships, ordering process, and the API, among others. Components may have individual security policies to reduce the possibility of security vulnerabilities within the system.

Referring to FIGS. 3D and 3E, depicted are various GUIs in connection with managing end user accounts. An end user profile may be an account profile publicly accessible by other end users. By default, certain profile attributes may be public, such as a photo, an avatar, a profile name, a wallet balance, sending or receiving gift, member information (e.g., short bio, website links, etc.), and user feed, among others. Referring first to FIG. 3D, shown is a screenshot of a user's list GUI 300D. Using the user's list GUI 300D, the administrator may view, edit, and validate accounts of administrators, end users, and vendors, among others. Referring now to FIG. 3E, depicted is an edit user interface 300E. With the edit user interface 300E, the administrator may add customized user fields. The fields may be based on other information provided by the end user besides the billing information, such as interest.

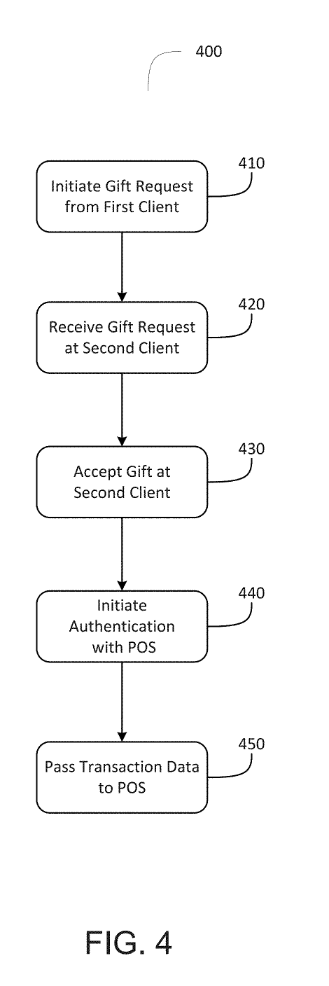

Referring now to FIG. 4, depicted is a method 400 of purchasing an item for another person via an application and point of sales systems. The functionalities of method 400 may be performed by system 100 as detailed in conjunction with FIG. 1 or the computing system 500 as described in conjunction with FIGS. 5A-5D. In brief overview, a gift sender may initiate a gift request using an end-user application from a first client (410). The gift request may include a transaction amount, one or more selected products or services, information regarding the gift recipient, and information regarding the vendor, among others. The gift recipient may receive the gift request using an end-user application on a second client (420). The application may display a prompt to accept or reject the gift recipient. The gift recipient may indicate acceptance of gift using the end-user application at the second client (430). The acceptance may be forwarded to a point of sale (POS) unit at the vendor associated with the gift request. The first client may initiate authentication with the POS unit to process the gift transaction (440). The authentication process may be in accordance to a handshake procedure. The end-user application on the first client may pass transaction data for carrying out the gift transaction to the POS unit (450). The POS unit in turn may complete the gift transaction with a payment processing service.

In further detail, a gift sender may initiate a gift request using an end-user application from a first client (410). The gift sender may be notified via the application that a gift recipient is at the vendor location. The notification may be sent to the gift sender, when the gift recipient submits a check-in notification on an end-user application on a second client. In response, the gift sender may send the gift request via the application on the first client. The gift request may include a transaction amount, one or more selected products or services, information regarding the gift recipient, and information regarding the vendor, among others.

The gift recipient may receive the gift request using an end-user application on a second client (420). The gift request may be forwarded to the end-user application the second client from the application on the first client via a server. The application may display a prompt to accept or reject the gift recipient. The prompt may be presented to the gift recipient on the second client via the application. The prompt may include the contents of the gift request, and may include the transaction, the one or more selected products or services, the information regarding the gift recipient, and the information regarding the vendor, among others.

The gift recipient may indicate acceptance of gift using the end-user application at the second client (430). The acceptance may be forwarded to a point of sale (POS) unit at the vendor associated with the gift request via the server. The acceptance may be also forwarded to the gift sender of the first client via the server. In addition, the gift recipient may indicate rejection of the gift using the end-user application on the second client. The rejection may be forwarded to the gift sender of the first client via the server.

The first client may initiate authentication with the POS unit to process the gift transaction (440). The initiation of the authentication may be responsive to the receipt of the acceptance or the receipt of the gift request at the server. The authentication process may be in accordance to a handshake procedure. The authentication may be between the first client and the server and between the server and the POS unit. With authenticating the first client, an encrypted communication channel may be established from the first client to the POS unit via the server. Keys generated using the acceptance may be used to establish the encrypted communication channel.

The end-user application on the first client may pass transaction data for carrying out the gift transaction to the POS unit (450). The transaction data may include an account identifier of the gift sender, billing information for the gift sender, a total transaction for the gift, and a transaction identifier. Upon receipt of the transaction data, the POS unit may execute the transaction with a payment processing service in accordance with the specifications of the transaction data. In this manner, the gift sender may initiate and carry out the transaction remotely using the application on the first client.

### B. Computing and Network Environment

It may be helpful to describe aspects of the operating environment as well as associated system components (e.g., hardware elements) in connection with the methods and systems described herein. Referring to FIG. 5A, an embodiment of a network environment is depicted. In brief overview, the illustrated exploring network environment includes one or more clients 502a-502n (also generally referred to as local machine(s) 502, client(s) 502, client node(s) 502, client machine(s) 502, client computer(s) 502, client device(s) 502, endpoint(s) 502, or endpoint node(s) 502) in communication with one or more servers 506a-506n (also generally referred to as server(s) 506, node 506, or remote machine(s) 506) via one or more networks 504. In some embodiments, a client 502 has the capacity to function as both a client node seeking access to resources provided by a server and as a server providing access to hosted resources for other clients 502a-502n.

Although FIG. 5A shows a network 504 between the clients 502 and the servers 506, the clients 502 and the servers 506 may be on the same network 504. In some embodiments, there are multiple networks 504 between the clients 502 and the servers 506. In one of these embodiments, a network 504′ (not shown) may be a private network and a network 504 may be a public network. In another of these embodiments, a network 504 may be a private network and a network 504′ a public network. In still another of these embodiments, networks 504 and 504′ may both be private networks.

The network 504 may be connected via wired or wireless links. Wired links may include Digital Subscriber Line (DSL), coaxial cable lines, or optical fiber lines. The wireless links may include BLUETOOTH, Wi-Fi, NFC, RFID Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 504 may be any type and/or form of network. The geographical scope of the network 504 may vary widely and the network 504 can be a body area network (BAN), a personal area network (PAN), a local-area network (LAN), e.g. Intranet, a metropolitan area network (MAN), a wide area network (WAN), or the Internet. The topology of the network 504 may be of any form and may include, e.g., any of the following: point-to-point, bus, star, ring, mesh, or tree. The network 504 may be an overlay network, which is virtual and sits on top of one or more layers of other networks 504′. The network 504 may be of any such network topology as known to those ordinarily skilled in the art capable of supporting the operations described herein. The network 504 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 504 may be a type of a broadcast network, a telecommunications network, a data communication network, or a computer network.

In some embodiments, the system may include multiple, logically-grouped servers 506. In one of these embodiments, the logical group of servers may be referred to as a server farm 38 or a machine farm 38. In another of these embodiments, the servers 506 may be geographically dispersed. In other embodiments, a machine farm 38 may be administered as a single entity. In still other embodiments, the machine farm 38 includes a plurality of machine farms 38. The servers 506 within each machine farm 38 can be heterogeneous—one or more of the servers 506 or machines 506 can operate according to one type of operating system platform (e.g., WINDOWS NT, manufactured by Microsoft Corp. of Redmond, Wash.), while one or more of the other servers 506 can operate on according to another type of operating system platform (e.g., Unix, Linux, or Mac OS X).

In one embodiment, servers 506 in the machine farm 38 may be stored in high-density rack systems, along with associated storage systems, and located in an enterprise data center. In this embodiment, consolidating the servers 506 in this way may improve system manageability, data security, the physical security of the system, and system performance by locating servers 506 and high performance storage systems on localized high performance networks. Centralizing the servers 506 and storage systems and coupling them with advanced system management tools allows more efficient use of server resources.

The servers 506 of each machine farm 38 do not need to be physically proximate to another server 506 in the same machine farm 38. Thus, the group of servers 506 logically grouped as a machine farm 38 may be interconnected using a wide-area network (WAN) connection or a metropolitan-area network (MAN) connection. For example, a machine farm 38 may include servers 506 physically located in different continents or different regions of a continent, country, state, city, campus, or room. Data transmission speeds between servers 506 in the machine farm 38 can be increased if the servers 506 are connected using a local-area network (LAN) connection or some form of direct connection. Additionally, a heterogeneous machine farm 38 may include one or more servers 506 operating according to a type of operating system, while one or more other servers 506 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 506 may comprise components, subsystems and modules to support one or more management services for the machine farm 38. In one of these embodiments, one or more servers 506 provide functionality for management of dynamic data, including techniques for handling failover, data replication, and increasing the robustness of the machine farm 38. Each server 506 may communicate with a persistent store and, in some embodiments, with a dynamic store. Server 506 may be a file server, application server, web server, proxy server, appliance, network appliance, gateway, gateway server, virtualization server, deployment server, SSL VPN server, or firewall. In one embodiment, the server 506 may be referred to as a remote machine or a node.

Referring to FIG. 5B, a cloud computing environment is depicted. A cloud computing environment may provide client 502 with one or more resources provided by a network environment. The cloud computing environment may include one or more clients 502a-502n, in communication with the cloud 508 over one or more networks 504. Clients 502 may include, e.g., thick clients, thin clients, and zero clients. A thick client may provide at least some functionality even when disconnected from the cloud 508 or servers 506. A thin client or a zero client may depend on the connection to the cloud 508 or server 506 to provide functionality. A zero client may depend on the cloud 508 or other networks 504 or servers 506 to retrieve operating system data for the client device. The cloud 508 may include back end platforms, e.g., servers 506, storage, server farms or data centers.

The cloud 508 may be public, private, or hybrid. Public clouds may include public servers 506 that are maintained by third parties to the clients 502 or the owners of the clients. The servers 506 may be located off-site in remote geographical locations as disclosed above or otherwise. Public clouds may be connected to the servers 506 over a public network. Private clouds may include private servers 506 that are physically maintained by clients 502 or owners of clients. Private clouds may be connected to the servers 506 over a private network 504. Hybrid clouds 508 may include both the private and public networks 504 and servers 506.

The cloud 508 may also include a cloud based delivery, e.g. Software as a Service (SaaS) 510, Platform as a Service (PaaS) 512, and Infrastructure as a Service (IaaS) 514. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 502 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 502 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 502 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 502 may also access SaaS resources through smartphone or tablet applications, including, e.g., Salesforce Sales Cloud, or Google Drive app. Clients 502 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 502 and server 506 may be deployed as and/or executed on any type and form of computing device, e.g. a computer, network device or appliance capable of communicating on any type and form of network and performing the operations described herein. FIGS. 5C and 5D depict block diagrams of a computing device 500 useful for practicing an embodiment of the client 502 or a server 506. As shown in FIGS. 5C and 5D, each computing device 500 includes a central processing unit 521, and a main memory unit 522. As shown in FIG. 5C, a computing device 500 may include a storage device 528, an installation device 516, a network interface 518, an I/O controller 523, display devices 524a-524n, a keyboard 526 and a pointing device 527, e.g. a mouse. The storage device 528 may include, without limitation, an operating system, and/or software 520. As shown in FIG. 5D, each computing device 500 may also include additional optional elements, e.g. a memory port 503, a bridge 570, one or more input/output devices 530a-530n (generally referred to using reference numeral 530), and a cache memory 540 in communication with the central processing unit 521.

The central processing unit 521 is any logic circuitry that responds to and processes instructions fetched from the main memory unit 522. In many embodiments, the central processing unit 521 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 500 may be based on any of these processors, or any other processor capable of operating as described herein. The central processing unit 521 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 522 may include one or more memory chips capable of storing data and allowing any storage location to be directly accessed by the microprocessor 521. Main memory unit 522 may be volatile and faster than storage 528 memory. Main memory units 522 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 522 or the storage 528 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 522 may be based on any of the above described memory chips, or any other available memory chips capable of operating as described herein. In the embodiment shown in FIG. 5C, the processor 521 communicates with main memory 522 via a system bus 550 (described in more detail below). FIG. 5D depicts an embodiment of a computing device 500 in which the processor communicates directly with main memory 522 via a memory port 503. For example, in FIG. 5D the main memory 522 may be DRDRAM.

FIG. 5D depicts an embodiment in which the main processor 521 communicates directly with cache memory 540 via a secondary bus, sometimes referred to as a backside bus. In other embodiments, the main processor 521 communicates with cache memory 540 using the system bus 550. Cache memory 540 typically has a faster response time than main memory 522 and is typically provided by SRAM, BSRAM, or EDRAM. In the embodiment shown in FIG. 5D, the processor 521 communicates with various I/O devices 530 via a local system bus 550. Various buses may be used to connect the central processing unit 521 to any of the I/O devices 530, including a PCI bus, a PCI-X bus, or a PCI-Express bus, or a NuBus. For embodiments in which the I/O device is a video display 524, the processor 521 may use an Advanced Graphics Port (AGP) to communicate with the display 524 or the I/O controller 523 for the display 524. FIG. 5D depicts an embodiment of a computer 500 in which the main processor 521 communicates directly with I/O device 530b or other processors 521′ via HYPERTRANSPORT, RAPIDIO, or INFINIBAND communications technology. FIG. 5D also depicts an embodiment in which local busses and direct communication are mixed: the processor 521 communicates with I/O device 530a using a local interconnect bus while communicating with I/O device 530b directly.

A wide variety of I/O devices 530a-530n may be present in the computing device 500. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 530a-530n may include a combination of multiple input or output devices, including, e.g., Microsoft KINECT, Nintendo Wiimote for the WII, Nintendo WII U GAMEPAD, or Apple IPHONE. Some devices 530a-530n allow gesture recognition inputs through combining some of the inputs and outputs. Some devices 530a-530n provides for facial recognition which may be utilized as an input for different purposes including authentication and other commands. Some devices 530a-530n provides for voice recognition and inputs, including, e.g., Microsoft KINECT, SIRI for IPHONE by Apple, Google Now or Google Voice Search.

Additional devices 530a-530n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 530a-530n, display devices 524a-524n or group of devices may be augment reality devices. The I/O devices may be controlled by an I/O controller 523 as shown in FIG. 5C. The I/O controller may control one or more I/O devices, such as, e.g., a keyboard 526 and a pointing device 527, e.g., a mouse or optical pen. Furthermore, an I/O device may also provide storage and/or an installation medium 516 for the computing device 500. In still other embodiments, the computing device 500 may provide USB connections (not shown) to receive handheld USB storage devices. In further embodiments, an I/O device 530 may be a bridge between the system bus 550 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 524a-524n may be connected to I/O controller 523. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 524a-524n may also be a head-mounted display (HMD). In some embodiments, display devices 524a-524n or the corresponding I/O controllers 523 may be controlled through or have hardware support for OPENGL or DIRECTX API or other graphics libraries.

In some embodiments, the computing device 500 may include or connect to multiple display devices 524a-524n, which each may be of the same or different type and/or form. As such, any of the I/O devices 530a-530n and/or the I/O controller 523 may include any type and/or form of suitable hardware, software, or combination of hardware and software to support, enable or provide for the connection and use of multiple display devices 524a-524n by the computing device 500. For example, the computing device 500 may include any type and/or form of video adapter, video card, driver, and/or library to interface, communicate, connect or otherwise use the display devices 524a-524n. In one embodiment, a video adapter may include multiple connectors to interface to multiple display devices 524a-524n. In other embodiments, the computing device 500 may include multiple video adapters, with each video adapter connected to one or more of the display devices 524a-524n. In some embodiments, any portion of the operating system of the computing device 500 may be configured for using multiple displays 524a-524n. In other embodiments, one or more of the display devices 524a-524n may be provided by one or more other computing devices 500a or 500b connected to the computing device 500, via the network 504. In some embodiments software may be designed and constructed to use another computer's display device as a second display device 524a for the computing device 500. For example, in one embodiment, an Apple iPad may connect to a computing device 500 and use the display of the device 500 as an additional display screen that may be used as an extended desktop. One ordinarily skilled in the art will recognize and appreciate the various ways and embodiments that a computing device 500 may be configured to have multiple display devices 524a-524n.

Referring again to FIG. 5C, the computing device 500 may comprise a storage device 528 (e.g. one or more hard disk drives or redundant arrays of independent disks) for storing an operating system or other related software, and for storing application software programs such as any program related to the software 520. Examples of storage device 528 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 528 may be non-volatile, mutable, or read-only. Some storage device 528 may be internal and connect to the computing device 500 via a bus 550. Some storage device 528 may be external and connect to the computing device 500 via an I/O device 530 that provides an external bus. Some storage device 528 may connect to the computing device 500 via the network interface 518 over a network 504, including, e.g., the Remote Disk for MACBOOK AIR by Apple. Some client devices 500 may not require a non-volatile storage device 528 and may be thin clients or zero clients 502. Some storage device 528 may also be used as an installation device 516, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 500 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 502. An application distribution platform may include a repository of applications on a server 506 or a cloud 508, which the clients 502a-502n may access over a network 504. An application distribution platform may include application developed and provided by various developers. A user of a client device 502 may select, purchase and/or download an application via the application distribution platform.

Furthermore, the computing device 500 may include a network interface 518 to interface to the network 504 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 500 communicates with other computing devices 500′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 518 may comprise a built-in network adapter, network interface card, PCMCIA network card, EXPRESSCARD network card, card bus network adapter, wireless network adapter, USB network adapter, modem or any other device suitable for interfacing the computing device 500 to any type of network capable of communication and performing the operations described herein.

A computing device 500 of the sort depicted in FIGS. 5B and 5C may operate under the control of an operating system, which controls scheduling of tasks and access to system resources. The computing device 500 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 500 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 500 has sufficient processor power and memory capacity to perform the operations described herein. In some embodiments, the computing device 500 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 500 is a gaming system. For example, the computer system 500 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 500 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 500 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 500 is a tablet e.g. the IPAD line of devices by Apple; GALAXY TAB family of devices by Samsung; or KINDLE FIRE, by Amazon.com, Inc. of Seattle, Wash. In other embodiments, the computing device 500 is an eBook reader, e.g. the KINDLE family of devices by Amazon.com, or NOOK family of devices by Barnes & Noble, Inc. of New York City, N.Y.

In some embodiments, the communications device 502 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 502 is a laptop or desktop computer equipped with a web browser and a microphone and speaker system, e.g. a telephony headset. In these embodiments, the communications devices 502 are web-enabled and can receive and initiate phone calls. In some embodiments, a laptop or desktop computer is also equipped with a webcam or other video capture device that enables video chat and video call. In some embodiments, the communication device 502 is a wearable mobile computing device including but not limited to Google Glass and Samsung Gear.

In some embodiments, the status of one or more machines 502, 506 in the network 504 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

The description herein including modules emphasizes the structural independence of the aspects of the controller, and illustrates one grouping of operations and responsibilities of the controller. Other groupings that execute similar overall operations are understood within the scope of the present application. Modules may be implemented in hardware and/or as computer instructions on a non-transient computer readable storage medium, and modules may be distributed across various hardware or computer based components.

Example and non-limiting module implementation elements include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

Non-limiting examples of various embodiments are disclosed herein. Features from one embodiments disclosed herein may be combined with features of another embodiment disclosed herein as someone of ordinary skill in the art would understand.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1. A method of remotely executing transactions to point of sale systems of establishments to purchase items on behalf of users, comprising:
receiving, by a server having one or more processors from a first client via a network, an indication that a first end user of the first client is at an establishment having a point of sale (POS) system;
identifying, by the server, responsive to receiving the indication, information regarding one or more items offered for purchase at an establishment associated with the POS system;
providing, by the server to a second client of a second end user via the network, a notification that the first end user is at the establishment, the notification including one or more items to select by the second end user to purchase at the establishment via the POS system on behalf of the first end user;
receiving, by the server from the second client via the network, a request to initiate a transaction to purchase one or more items via the POS system selected by the second end user on the second client on behalf of the first end user on the first client, the request comprising one or more items selected by the second end user and a transaction amount;
providing, by the server to the first client via the network, the request to initiate the transaction for acceptance or rejection by the first end user of the first client;
receiving, by the server from the first client via the network, a response indicating acceptance of the transaction by the first end user of the first client to the request to initiate the transaction;
authenticating, by the server responsive to receiving the response indicating acceptance of the transaction, the second end user on the second client with the server to establish an encrypted communication channel between the second client and the server over the network;
receiving, by the server via the encrypted communication channel established over the network, transaction data to carry out the transaction via the POS system, the transaction data including the transaction amount and a billing information for the second end user; and
providing, by the server, the transaction data to the POS system to carry out the transaction via the POS system in accordance with the transaction amount and the billing information included in the transaction information.

2. The method of claim 1, wherein receiving the indication further comprises receiving the indication corresponding to a check-in via a first application running on the first client to the establishment at which the first user is located.

3. The method of claim 1, wherein providing the notification that the first end user is at the establishment further comprises identifying, from a plurality of end users, the second end user as associated with the first end user based on the indication that the first end user of the first client is at the establishment.

4. The method of claim 1, wherein providing the notification that the first end user is at the establishment further comprises causing an application running on the second client to present the indication on a graphical user interface of the application to denote that the first end user is at the establishment and a list including the one or more items offered for purchase at the establishment.

5. The method of claim 1, wherein providing the request to initiate further comprises causing an application running on the first client to present a prompt to the first end user to indicate the selected item to purchase the establishment and to accept or reject the notification.

6. The method of claim 1, wherein authenticating the second end user further comprises using one or more keys generated based on the acceptance message from the first end user to establish the encrypted communication channel between the second client and the server.

7. The method of claim 1, wherein receiving the transaction data further comprises receiving the transaction data generated in accordance with a predefined format specified by an application programming interface (API).

8. The method of claim 1, further comprising authenticating, by the server responsive to authenticating with the second client, the POS system with the server to establish a second encrypted communication channel between the POS system and the server to forward the transaction data received from the second client via the encrypted communication channel.

9. The method of claim 1, further comprising interfacing, by the server via the network, with a reservation management system (RMS) to access calendar events of the first end user of the first client regarding the establishment.

10. The method of claim 1, further comprising receiving, by the server via the network, a return message from the POS system responsive to carrying out the transaction in accordance with the transaction amount and the billing information, the return message indicating one of success or failure in carrying out the transaction via the POS system to provide the selected item to the first end user.

11. A system for remotely executing transactions to point of sale systems of establishments to purchase items on behalf of users, comprising:
a check-in tracker executable on a server having one or more processors, configured to:
receive, from a first client via a network, an indication that a first end user of the first client is at an establishment having a point of sale (POS) system;
identify, responsive to receiving the indication, information regarding one or more items offered for purchase at an establishment associated with the POS system; and
provide, to a second client of a second end user via the network, a notification that the first end user is at the establishment, the notification including one or more items to select by the second end user to purchase at the establishment via the POS system on behalf of the first end user;
a request handler executable on the server, configured to:
receive, from the second client via the network, a request to initiate a transaction to purchase one or more items via the POS system selected by the second end user on the second client on behalf of the first end user on the first client, the request comprising one or more items selected by the second end user and a transaction amount;
provide, to the first client via the network, the request to initiate the transaction for acceptance or rejection by the first end user of the first client; and
receive, from the first client via the network, a response indicating acceptance of the transaction by the first end user of the first client to the request to initiate the transaction;
a user authenticator executable on the server, configured to authenticate, responsive to receiving the response indicating acceptance of the transaction, the second end user on the second client with the server to establish an encrypted communication channel between the second client and the server over the network; and
a transaction processor executable on the server, configured to:
receive, via the encrypted communication channel established over the network, transaction data to carry out the transaction via the POS system, the transaction data including the transaction amount and a billing information for the second end user; and
provide the transaction data to the POS system to carry out the transaction via the POS system in accordance with the transaction amount and the billing information included in the transaction information.

12. The system of claim 11, wherein the check-in tracker is further configured to receive the indication corresponding to a check-in via a first application running on the first client to the establishment at which the first user is located.

13. The system of claim 11, wherein the check-in tracker is further configured to identify, from a plurality of end users, the second end user as associated with the first end user based on the indication that the first end user of the first client is at the establishment.

14. The system of claim 11, wherein the check-in tracker is further configured to cause an application running on the second client to present the indication on a graphical user interface of the application to denote that the first end user is at the establishment and a list including the one or more items offered for purchase at the establishment.

15. The system of claim 11, wherein the request handler is further configured to cause an application running on the first client to present a prompt to the first end user to indicate the selected item to purchase the establishment and to accept or reject the notification.

16. The system of claim 11, wherein the user authenticator is further configured to use one or more keys generated based on the acceptance message from the first end user to establish the encrypted communication channel between the second client and the server.

17. The system of claim 11, wherein the user authenticator is further configured to receive the transaction data generated in accordance with a predefined format specified by an application programming interface (API).

18. The system of claim 11, wherein the user authenticator is further configured to authenticate, responsive to authenticating with the second client, the POS system with the server to establish a second encrypted communication channel between the POS system and the server to forward the transaction data received from the second client via the encrypted communication channel.

19. The system of claim 11, wherein the check-in tracker is further configured to interface, via the network, with a reservation management system (RMS) to access calendar events of the first end user of the first client regarding the establishment.

20. The system of claim 11, wherein the transaction processor is further configured to receive, via the network, a return message from the POS system responsive to carrying out the transaction in accordance with the transaction amount and the billing information, the return message indicating one of success or failure in carrying out the transaction via the POS system to provide the selected item to the first end user.
